(19) United States
(12) Patent Application Publication
(10) Pub. No.: US 2012/0150758 A1
(43) Pub. Date: Jun. 14, 2012

(54) Efficiency of use of a common product

(75) Inventors: Christian L. Belady, Mercer Island, WA (US); Rod Bernard, Redmond, WA (US); Angel Sarmento Calvo, Redmond, WA (US); Larry Cochrane, Redmond, WA (US); Jason Garms, Redmond, WA (US); Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US); Jennifer Mame Pollard, Redmond, WA (US); John D. Rinaldo, JR., Bellevue, WA (US); Clarence T. Tegreene, Bellevue, WA (US); Rene A. Vega, Scotts Valley, CA (US); Lowell L. Wood, JR., Bellevue, WA (US); Feng Zhao, Redmond, WA (US)

(73) Assignee: Elwha LLC, a limited liability corporation of the State of Delaware

(21) Appl. No.: 13/317,726

(22) Filed: Oct. 26, 2011

Related U.S. Application Data
(63) Continuation-in-part of application No. 12/928,638, filed on Dec. 14, 2010.
Application No. 12/928,638 is a continuation-in-part of application No. 13/135,674, filed on Jul. 12, 2011.
Application No. 13/135,674 is a continuation-in-part of application No. 13/135,683, filed on Jul. 12, 2011.
Application No. 13/135,683 is a continuation-in-part of application No. 13/199,475, filed on Aug. 31, 2011.
Application No. 13/199,475 is a continuation-in-part of application No. 13/199,476, filed on Aug. 31, 2011.
Application No. 13/199,476 is a continuation-in-part of application No. 13/199,995, filed on Sep. 14, 2011.
Application No. 13/199,995 is a continuation-in-part of application No. 13/200,809, filed on Sep. 30, 2011.
Application No. 13/200,809 is a continuation-in-part of application No. 13/200,807, filed on Sep. 30, 2011.
Application No. 13/200,807 is a continuation-in-part of application No. 13/317,728, filed on Oct. 26, 2011.

(51) Int. Cl. G06Q 99/00

(52) U.S. Cl. 705/317

(57) ABSTRACT

Systems and methods for determining efficiency-of-use scores related to uses of a product by two or more users may implement operations including, but not limited to: computing an efficiency-of-use score associated with a use of a first physical product of a set of products by a first user and an efficiency-of-use score associated with a use of a second physical product of the set of products by a second user; comparing the efficiency-of-use score associated with the use of the first physical product by the first user to the efficiency-of-use score associated with the use of the second physical product by the second user; and providing a notification according to the comparison of an efficiency-of-use score associated with the use of the first product by the first user to an efficiency-of-use score associated with the use of the second product by the second user.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications, including any priority claims, is incorporated herein by reference to the extent such subject matter is not inconsistent herewith.

### RELATED APPLICATIONS

For purposes of the USPTO extra-statutory requirements, the present application constitutes a continuation-in-part of U.S. patent application Ser. No. 12/928,638, entitled LIFECYCLE IMPACT INDICATORS, naming Mark Aggar, Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed 14 Dec. 2010, which is currently co-pending or is an application of which a currently co-pending application is entitled to the benefit of the filing date.

For purposes of the USPTO extra-statutory requirements, the present application constitutes a continuation-in-part of the U.S. patent application Ser. No. 13/135,674 having an entitled EFFICIENCY-OF-USE TECHNIQUES, naming Mark Aggar, Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed Jul. 12, 2011, which is currently co-pending or is an application of which a currently co-pending application is entitled to the benefit of the filing date.

For purposes of the USPTO extra-statutory requirements, the present application constitutes a continuation-in-part of the U.S. patent application Ser. No. 13/135,683 entitled USER AS PART OF A SUPPLY CHAIN, naming Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed Jul. 12, 2011, which is currently co-pending or is an application of which a currently co-pending application is entitled to the benefit of the filing date.

For purposes of the USPTO extra-statutory requirements, the present application constitutes a continuation-in-part of the U.S. patent application Ser. No. 13/199,475, entitled EFFICIENCY OF USE OF A SHARED PRODUCT naming Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed Aug. 31, 2011, which is currently co-pending or is an application of which a currently co-pending application is entitled to the benefit of the filing date.

For purposes of the USPTO extra-statutory requirements, the present application constitutes a continuation-in-part of the U.S. patent application Ser. No. 13/199,476, entitled ECOLOGICAL IMPACT QUANTIFICATION IDENTIFIERS naming Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed Aug. 31, 2011, which is currently co-pending or is an application of which a currently co-pending application is entitled to the benefit of the filing date.

For purposes of the USPTO extra-statutory requirements, the present application constitutes a continuation-in-part of the U.S. patent application Ser. No. 13/199,995, entitled MONITORING EFFICIENCY AND ECOLOGICAL IMPACT ASSOCIATED WITH A USE OF A PRODUCT naming Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed Sep. 14, 2011, which is currently co-pending or is an application of which a currently co-pending application is entitled to the benefit of the filing date.

For purposes of the USPTO extra-statutory requirements, the present application constitutes a continuation-in-part of the U.S. patent application Ser. No. 13/200,809, entitled PUBLICATION OF EFFICIENCY AND ECOLOGICAL IMPACT DATA TO A SOCIAL MEDIA INTERFACE naming Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed Sep. 30, 2011, which is currently co-pending or is an application of which a currently co-pending application is entitled to the benefit of the filing date.

For purposes of the USPTO extra-statutory requirements, the present application constitutes a continuation-in-part of the U.S. patent application Ser. No. 13/200,807, entitled DISPOSAL MODE ECOLOGICAL IMPACT MONITORING naming Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed Sep. 30, 2011, which is currently co-pending or is an application of which a currently co-pending application is entitled to the benefit of the filing date.

For purposes of the USPTO extra-statutory requirements, the present application constitutes a continuation-in-part of the United States patent application having attorney docket number 0109-003-021-000000, entitled ECOLOGICAL IMPACT COMPLIANCE naming Christian Belady, Rob Bernard, Angel Calvo, Larry Cochrane, Jason Garms, Roderick A. Hyde, Royce A. Levien, Richard T. Lord, Robert W. Lord, Mark A. Malamud, Jennifer Pollard, John D. Rinaldo, Jr., Clarence T. Tegreene, Rene Vega, Lowell L. Wood, Jr., and Feng Zhao, as inventors, filed Oct. 26, 2011, which is currently co-pending or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above, but expressly points out that such designation(s) are not to be construed in any way as any type of commentary and/or admission as to whether or not the present application contains any new matter in addition to the matter of its parent application(s).

### SUMMARY

Systems, methods, computer-readable storage mediums including computer-readable instructions and/or circuitry for determining efficiency-of-use scores related to uses of a product by two or more users may implement operations including, but not limited to: computing an efficiency-of-use score associated with a use of a first physical product of a set of products by a first user and an efficiency-of-use score associated with a use of a second physical product of the set of products by a second user; comparing the efficiency-of-use score associated with the use of the first physical product by the first user to the efficiency-of-use score associated with the use of the second physical product by the second user; and providing a notification according to the comparison of an efficiency-of-use score associated with the use of the first product by the first user to an efficiency-of-use score associated with the use of the second product by the second user.

In one or more various aspects, related systems include but are not limited to circuitry and/or programming for effecting the herein referenced aspects; the circuitry and/or programming can be virtually any combination of hardware, software, and/or firmware configured to effect the herein-referenced method aspects depending upon the design choices of the system designer.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 shows a high-level block diagram of an operational environment.

FIG. 2 shows an exemplary high-level block diagram of an exemplary system.

FIG. 3 shows a high-level block diagram of a product.

FIG. 4 shows a high-level block diagram of a device.

FIG. 5 shows an operational procedure.

FIGS. 6-18 show alternative embodiments of the operational procedure of FIG. 5.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The consumption of rare materials and the ecological impact caused by human behavior are both becoming serious problems for the Earth. For example, some experts estimate that our use of the ecosystem to obtain food, timber, energy, exceeds the planet's ability to provide. As if the scarcity of resources was not enough of a problem, human behavior is also causing increasing amounts of greenhouse gasses to be emitted into the atmosphere. Certain greenhouse gasses, such as carbon monoxide, sulfur dioxide, chlorofluorocarbons (CFCs) and nitrogen oxides, are generated by manufacturing, using, and disposing of products and the general consensus is that these greenhouse gases cause harm to the environment. For example, according to the 2007 Fourth Assessment Report by the Intergovernmental Panel on Climate Change (IPCC), greenhouse gases have caused the global surface temperature increased 0.74±0.18 C (1.33±0.32 F) during the 20th century. Climate models project that the temperature will increase another 1.1 to 6.4 C (2.0 to 11.5 F) during the 21st century. It is likely that this increase in temperature is a significant problem for living creatures. For example, the living planet index, which is an indicator of the state of global biological diversity, shows that between the period of 1970 and 2003 biodiversity fell 30 percent.

While the demand for products is causing significant damage to the environment, most people are complacent. People generally indicate that they care about the environment; however, people typically do not act in an environment friendly way because they are not aware of how their actions truly affect the environment. On reason for this may be that impact is too abstract to appreciate. For example, a person may recognize that driving a car causes harm to the environment; however, the person may not appreciate how much harm it causes because the person is not penalized nor does the person have to perceive any link between their behavior and the damage caused.

Accordingly, robust methods, systems, and computer program products are provided to, among other things; bring about an operational system wherein users can perceive how consumption behavior affects the environment in relation to their use of a shared product. In an exemplary embodiment, multiple users' use of a shared product can be quantified and a score can be calculated that reflects how efficiently a given user is using or has used the product, perhaps in comparison to other users of the same shared product. For example, use data can be mapped to a discrete set of numbers (−99 to 99), or mapped to an abstract scale, e.g., “awful,” “bad,” “neutral,” “good,” and “exceptional” to express how efficiently each user of a shared product is using that product.

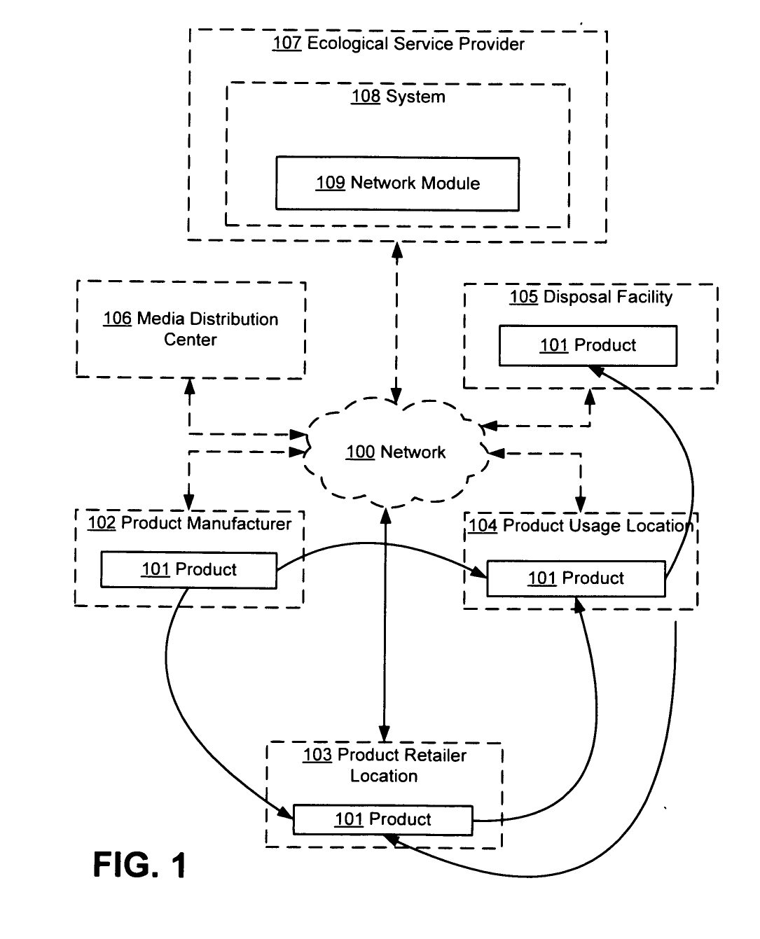

Referring now to FIG. 1, it illustrates a high-level block diagram of an exemplary operational environment that can be used to describe embodiments of the present disclosure. The arrows in dashed lines illustrate how product 102 can move through different locations throughout its life. The block-elements indicated in dashed lines are indicative of the fact that they are considered optional.

As an aside, each location within FIG. 1 can be interconnected via network 100, which may be the Internet. Each location can connect to network 100 using an access method such as, for example, a local area network (LAN), a wireless local area network (WLAN), personal area network (PAN), Worldwide Interoperability for Microwave Access (WiMAX), public switched telephone network (PTSN), general packet radio service (GPRS), cellular networks, and/or other types of wireless or wired networks.

FIG. 1 illustrates various points in the lifecycle of product 101, e.g., an appliance, vehicle, electronic device, food-services item, etc. At some point in time, product 101 can be manufactured by product manufacturer 102. For example, a company can purchase raw materials and/or manufactured materials and create product 101. After product 101 is manufactured, it can be optionally transported to product retailer 103 to be sold to a user (or sold directly to a user) or to a rental company such as a rental car company, an equipment rental company, a leasing center, etc., and transported to product usage location 104, e.g., a user's home, an office, a city, etc. During the use phase of product 101, one or more efficiency-of-use scores can be computed that reflect whether product 101 is being used or was used efficiently. For example, each time product 101 is used, product 101 can compute an efficiency-of-use score that is based on how product 101 was used as compared to a standard or as compared to the use of other users. In an exemplary embodiment, the efficiency-of-use score can be numerical value, and lower scores can reflect more efficient use.

A product 101 can be resold to product retailer 103 (or another product retailer), donated (not shown), or sold to another user (not shown). Eventually, product 101 will be fully consumed, i.e., used up, broken, etc., and can be disposed of. A product 101 can be transported to a product disposal facility 105, e.g., landfill, recycling facility, incineration facility, etc., where it can be disposed of.

A media distribution center 106 is also illustrated in FIG. 1. The media distribution center 106 can be maintained by the same organization that maintains server 106 or a separate entity. Generally, media distribution center 106 can be configured to receive; store; and/or disseminate information gathered by system 108. For example, media distribution center 106 can be configured to include a web server hosting a social media database, email server, short message service (“SMS”) server, television station, etc. In a specific example, media distribution center 106 can receive, store, and/or disseminate information such as efficiency-of-use scores.

In an exemplary embodiment, ecological service provider 107 can be used generate potential-ecological impact quantifications and communicate them (or information based on them) to users at different points in the lifecycle of product 101, which is described in more detail in U.S. patent application Ser. No. 12/928,638, entitled LIFECYCLE IMPACT INDICATORS.

In the same, or other embodiments system 108, which can include one or more computer systems having processors, memory, operating system software, network adaptors, etc., can be used to compute efficiency-of-use scores for users based on how they use products. For example, system 108 could be maintained by any number of individuals or organizations that wish to compute how efficiently users use products. In a specific example, system 108 could be maintained by the government. In this exemplary embodiment, the government can monitor how users use products (their own products) and compute efficiency-of-use scores. In another exemplary embodiment, system 108 can be controlled by a Green Organization, e.g., an entity that stands for reducing the impact humans have on the environment. In this example, enrollment with system 108 can be voluntary. In yet another exemplary embodiment, system 108 can be controlled by the owner of product 101, which could be a user or a company. In this case, the owner may require potential users to register with the system in order to use product 101. For example, if product is a rental car, system 108 could be controlled by the rental car company. In another specific example, system 108 could be controlled by a neighborhood or condo association that has communal assets that can be used by various members of the association. In this case, each person that lives in the neighborhood or is a member of the condo association may register with system 108 in order to use product 101. The system 108 may include a network module 109 configured to transceive signals between the ecological service provider 107 and one or more of the product manufacturer 102, product retailer 103, product usage location 104 and or product disposal facility 105 in order to obtain ecological impact and/or efficiency of use data associated with the product 101.

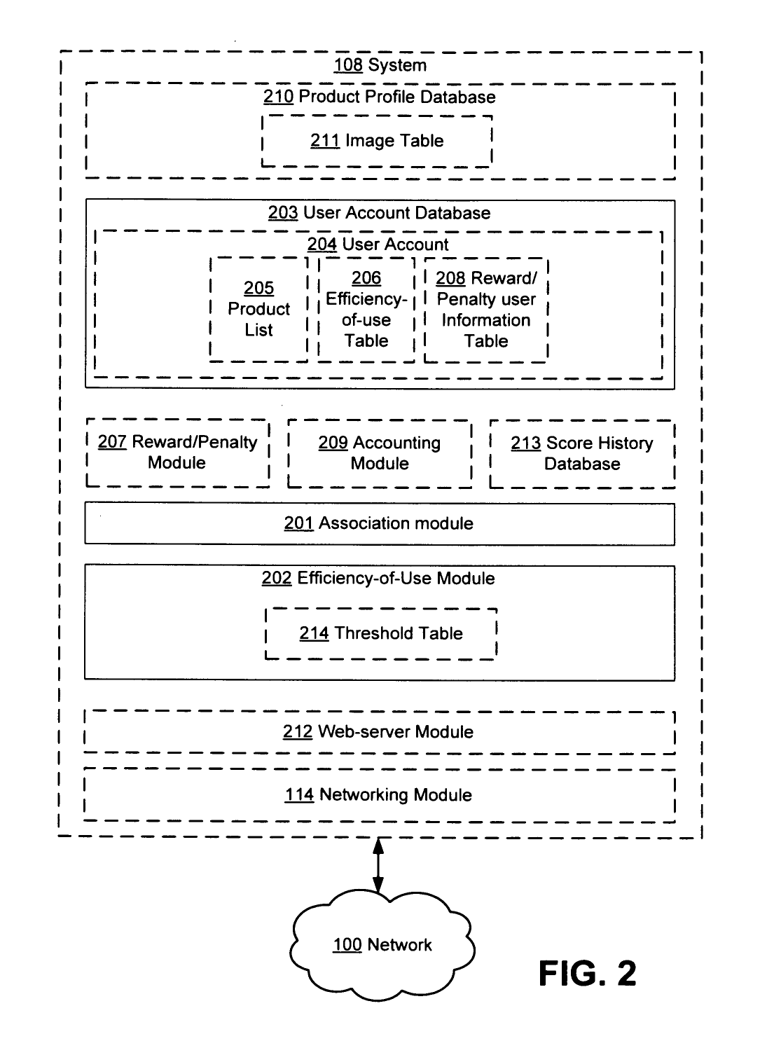

Referring now to FIG. 2, system 108 can also include association module 201, efficiency-of-use module 202 and user account database 203. The association module 201 can be a module of executable instructions that upon execution by a processor can cause the processor to link specific instances of a product to a user account. Briefly, each instance of a product tracked by system 108 can be assigned a unique identifier, e.g., a device-readable indicator or a device-readable indicator plus a unique serial number, and each user that could potentially use the tracked products can be assigned a user account, which can be stored in user account database 203. When a user takes control of a product, e.g., when he or she possesses product, association module 201 can create a relationship between information that identifies the account of a user, e.g., user account 204, and the identifier for product 101. The user account 204 is illustrated, which can be associated with user 300 described in more detail in the following paragraphs (while one user account is shown, user account database 203 of system 108 can maintain user accounts for a plurality of users).

The user account database 203 can be maintained by the entity that controls or uses system 108. For example, suppose system 108 is setup by a rental company. In this example, user account database 203 may include user accounts for users that contract with the rental company to rent a product. In another example, suppose system 108 is setup by an energy provider utility. In this example, user account database 203 may include user accounts for users that receive energy from the utility company.

Each user account 204, can optionally include a product list 205, which can contain a listing of products associated with user account 204, i.e., products rented, borrowed, or products that the user owns. Each product in the list can be associated with information that describes its status, e.g., owned, borrowed, or disposed of, the disposal method selected to dispose of the product, how long the product has been associated with the user account, a unique serial number for the product (which can be used to associate specific instances of a product with a specific user), etc.

In another embodiment, the user account 204 can be associated with one or more efficiency-of-use scores that reflect how efficiently the user has used or is using a product 101. In an exemplary embodiment, these scores can be stored in efficiency-of-use table 206. In the same, or another embodiment, a cumulative efficiency-of-use score can be generated and stored in efficiency-of-use table 206. Briefly, the cumulative efficiency-of-use score can be a combination of efficiency-of-use scores for different products. Similar to the potential-ecological-impact quantification described briefly above, an efficiency-of-use score can be a numerical value, e.g., a value from 0 to 10, −100 to 100, etc. In a specific example, higher efficiency-of-use scores could reflect more inefficient use. Thus, a score of 0 in a specific embodiment where the score runs from 0 to 10 would reflect an extremely efficient use whereas a score of 10 would reflect an incredibly inefficient use of a product. In other exemplary embodiments, the efficiency-of-use score could be an abstract indicator such as “bad” or “good.”

As described in more detail in the following paragraphs, one or more efficiency-of-use scores can be calculated and used in a variety of ways. For example, in a specific exemplary embodiment, reward/penalty module 207 can be configured to reward or penalize the user based on his or her efficiency-of-use score. After a user finishes using a product or while the user is using the product, an efficiency-of-use score can be computed and routed to reward/penalty module 207. The reward/penalty module 207 can process the efficiency-of-use score and determine whether to reward or penalize the user based on the score. If the user is penalized or rewarded, information can be stored in reward/penalty module 207. For example, a reward stored in reward/penalty information table 208 could include an icon indicative of a trophy created by an organization committed to acting in an environmentally friendly way. In another embodiment, reward/penalty information table 208 could include a graphic indicative of a coupon, a gift certificate, information indicating free or reduced services given to user 300, etc. Similarly, reward/penalty information table 208 can include penalties associated with user account 204 based on product use behavior. For example, a penalty could be a fee charged to user 300, a trophy with a negative association, etc. In another specific example, efficiency-of-use scores can be used to charge users based on inefficient use of products. For example, accounting module 209 can be configured to charge user accounts fees based on their efficiency-of-use score or scores.

Continuing with the brief overview of certain elements depicted within FIG. 2, efficiency-of-use module 202 can be used to compute efficiency-of-use scores. For example, efficiency-of-use module 202 in embodiments of the present disclosure can be configured to use efficiency information for one or more categories of data to compute an efficiency-of-use score that reflects how efficiently the user is using the product. In a simple example, a product could be a light bulb and efficiency information could be gathered that describes how much energy it uses over a time period, e.g., a day. In this example, the category of data for the light bulb is energy consumed per day. A more complex example may be for an automobile. In this example, data from multiple categories may be used to compute an efficiency-of-use score, e.g., miles per gallon of gasoline achieved data, number of passengers riding in the automobile, miles driven, brake force applied, etc.

In a specific example, each category of data used to compute a score can be associated with a use profile, which can be stored in product profile database 210. Each profile can indicate a standard that reflects efficient use for a category of data. For example, the light bulb referred to above could be associated with a use profile that defines an efficient amount of energy that a light bulb should use over a 24 hour period. In this example, the amount of energy actually used and the amount of energy that defines efficient use can be used to compute the efficiency-of-use score.

As shown in FIG. 2, product profile database 210 can be associated with tables of information, which can be used in exemplary embodiments of the present disclosure to configure efficiency-of-use module 202. Briefly, image table 211 can include images of products that can be associated with device-readable indicators. In an exemplary embodiment, a product 101 may not include device-readable indicator 303 (as described below) and efficiency-of-use module 202 can determine an identity of the product 101 from images.

Alternatively, a user account 204 can be tied into a social network where users can blog, post pictures, send message to each other, etc. In an exemplary embodiment, system 108 can include or be associated with a social networking service maintained by, for example, web-server module 212. The web-server module 212 can be configured to generate one or more web-pages that can be downloaded to computing devices, e.g., desktop personal-computers, smart phones, etc., that include logic operable to allow users to interact with each other. For example, web-server module 212 can send web-pages to computing devices that allow users to blog, post pictures, etc.

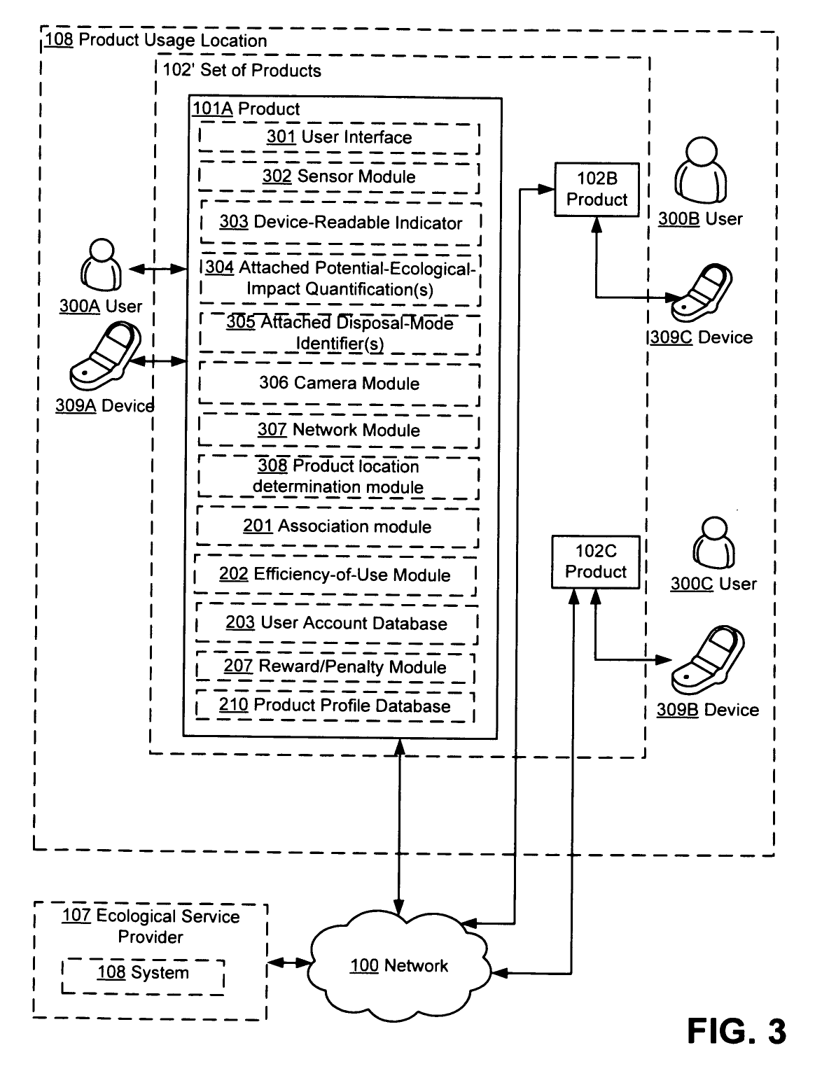

FIG. 3 generally illustrates an exemplary environment, which could be product usage location 104, e.g., a home, a company, a city, etc. wherein a product 101 is used by a user 300. As shown in FIG. 3, a product 101 (e.g. product 101A, product 101B, product 101C) can be a member of a set of products 101′. The set of products 101′ may include products 101 having substantially similar characteristics. For example, the products 101 may be: a common class of product (e.g. cell phones); from a common manufacturer (e.g. Apple®, Microsoft®, Google®, GE®, Ford®, and the like); from a common product line (e.g. all Prius® models); a common model of product 101 (e.g. iPhone® 4S); and/or may be configured in a similar manner (e.g. running a common operating system, including a common processor, having a common engine package, etc.).

The products 101 (e.g. e.g. product 101A, product 101B, product 101C) can be used by users 300 (e.g. user 300A, user 300B, user 300C) during their life. The use of product 101 by each user 300 can be monitored, for example by ecological service provider 107 (e.g. an agent of the owner of product 101 such as an employee of a rental car company, a product manufacturer 102, a product retailer 103, and/or a social media provider such as Facebook®, Twitter®, Google+®, etc.).

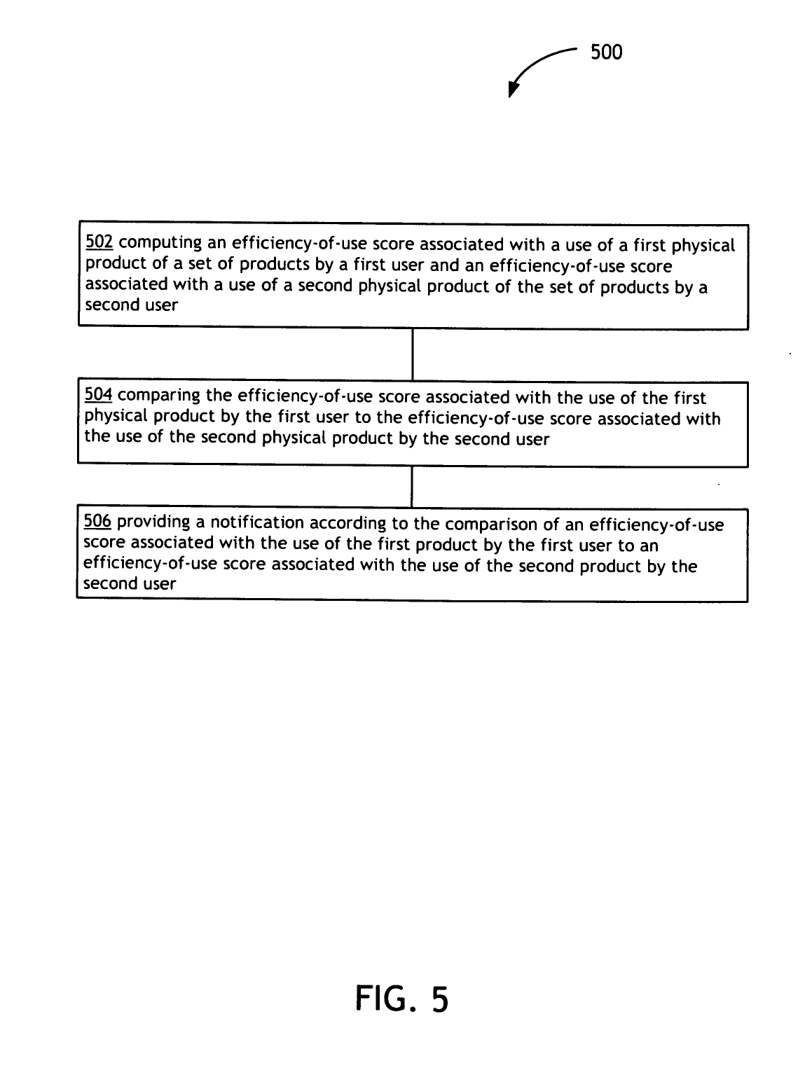

As shown by the FIG. 3, product 101 itself may include the association module 201, efficiency-of-use module 202, product profile database 210, reward/penalty module 207 of system 108, which may operate as described above with respect to the ecological service provider 107. Thus, in certain embodiments of the present disclosure, efficiency-of-use scores may be computed by the product itself using one or more use profiles that could be locally stored or stored by system 108. Accordingly, while certain operations described with respect to FIGS. 5-18 are described as being executed by system 108 in specific examples, the disclosure is not limited and each one of the operations described with respect to association module 201, efficiency-of-use module 202, and product profile database 210 could be executed on product 101.

As shown by FIG. 3, a product 101 may further include user interface 301, sensor module 302, device-readable indicator 303, one or more attached potential-ecological-impact quantification(s) 304, one or more attached disposal-mode identifier(s) 305, camera module 306, network module 307 and/or product location determination module 308 (e.g. a global positioning system (GPS) module). Briefly, user interface 301 can be any type of user interface such as a touch screen or a display and an input device, e.g., a mouse, touch pad, microphone, a keypad, a keyboard, etc. The sensor module 302, which is described in more detail below, can be the hardware and/or software operable to measure a physical quantity associated with the product 101 and convert it into an electrical signal. The product 101 can optionally include device-readable indicator 303, which can be information that can be extracted by device 309 in order to identify product 101. The device-readable indicator 303 could be an alphanumeric value, which can be stored in memory, e.g., RAM or ROM, in a barcode, in an RFID tag, or physically written on or etched into product 101. In an exemplary embodiment, device-readable indicator 303 can be stored with a unique serial number that also identifies the specific instance of product 101.

In an exemplary embodiment, a potential-ecological-impact quantification can be attached to product 101 in attached potential-ecological-impact quantification(s) 304. In this example, a device 309 or the ecological service provider 107 may be able to obtain one or more potential-ecological-impact quantification(s) 304 from product 101. Similar to the aforementioned device-readable indicator 303, attached potential-ecological-impact quantification(s) 304 can be stored in memory, a barcode, an RFID tag, and/or etched onto product 101.

In yet another embodiment, product 101 may have one or more attached disposal-mode identifier(s) 305. The disposal-mode identifier(s) 305 can include instructions, e.g., text, audio, images, for disposing of product according to a disposal mode, e.g., incineration, recycling, landfilling, etc.

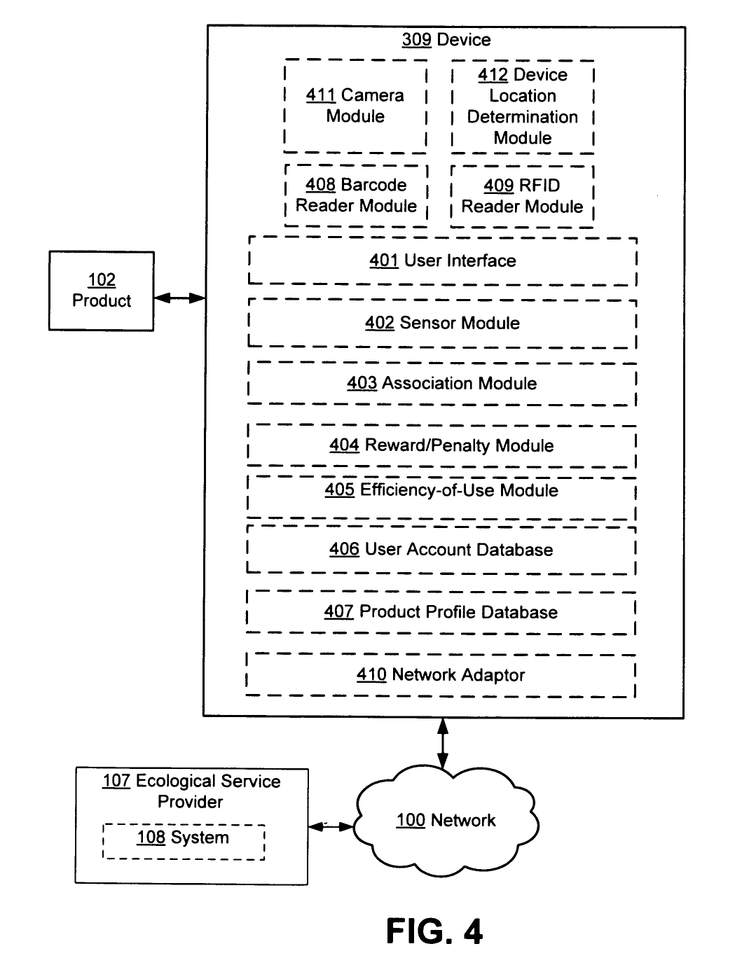

Referring to FIG. 4, it illustrates exemplary modules that can be integrated within device 309. The device 309 may be a computing/communication device including, for example, a cellular phone, a personal digital assistant (PDA), a laptop, a desktop, or other type of computing/communication device. In an exemplary embodiment, device 309 may be a handheld device such as a cellular telephone, a smart phone, a Mobile Internet Device (MID), an Ultra Mobile Personal Computer (UMPC), a convergent device such as a personal digital assistant (PDA), and so forth. For example, device can include memory, e.g., random access memory, ROM, etc., that can contain executable instructions that can be executed by a processor. In addition, device 309 can include various integrated circuits such as GPS radios, network interface adaptors, etc., and the associated firmware that operates such devices. The device 309 can include user interface 401, which could include, but is not limited to, input components implemented by a combination of hardware and software such as a touch user interface, a keypad, a directional pad, a microphone, etc., and output components such as a screen, e.g., an liquid crystal display, a speaker, etc.

The device 309 can further include sensor module 402, association module 403, reward/penalty module 404, efficiency-of-use module 405, user account database 406 and product profile database 407 that may operate similar to association module 201, efficiency-of-use module 202, reward/penalty module 207, user account database 203, and product profile database 210 as described above with respect to system 108 and/or product 101. Consequently, in embodiments of the present disclosure, the functionality described as being associated with association module 201, efficiency-of-use module 202, reward/penalty module 207, and product profile database 210 could be integrated within device 309. Thus, in certain embodiments of the present disclosure, efficiency-of-use scores may be computed by a device external to product 101 (e.g. device 309) using one or more use profiles that could be locally stored or stored by system 108. Accordingly, while certain operations described with respect to FIGS. 5-18 are described as being executed by system 108 in specific examples, the disclosure is not limited and each one of the operations described with respect to association module 201, efficiency-of-use module 202, reward/penalty module 207, and product profile database 210 could be executed on device 309.

The device 309 can obtain device-readable indicator 303 of the product 101 by communicating with product 101 and/or extracting it from product 101 using a barcode reader 408, RFID reader module 409, network adapter 410, or camera module 411. In other exemplary embodiments, product 101 may not have an attached device-readable indicator 303, instead device-readable indicator 303 can be looked up from an image of product 101, audio of a user speaking about product 101, or from user input received by user interface 401. The device 309 can obtain device location information using device location determination module 412 (e.g. a GPS module).

A user 300 can optionally use device 309 to obtain ecological information about product 101 such as potential-ecological-impact quantifications. For example, product 101 can include memory, e.g., a barcode, random access memory, read-only memory, etc., which can be used to store information that can be used by device 309 to obtain information based off potential-ecological-impact quantifications and/or the potential-ecological-impact quantifications themselves, among other things.

FIG. 5 and the following figures include various examples of operational flows, discussions and explanations may be provided with respect to the above-described exemplary environment of FIGS. 1-4. However, it should be understood that the operational flows may be executed in a number of other environments and contexts, and/or in modified versions of FIGS. 1-4. Also, although the various operational flows are presented in the sequence(s) illustrated, it should be understood that the various operations may be performed in different sequential orders other than those which are illustrated, or may be performed concurrently.

Further, in the following figures that depict various flow processes, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently.

FIG. 5 illustrates an operational procedure 500 for practicing aspects of the present disclosure including operations 502, 504 and/or 506.

Operation 502 shows computing an efficiency-of-use score associated with a use of a first physical product of a set of products by a first user and an efficiency-of-use score associated with a use of a second physical product of the set of products by a second user. Turning again back to FIGS. 1-4, an efficiency-of-use score can be computed, e.g., calculated, from information that described how product 101A was used during a period of time that user 300A has or had control of product 101A. For example, association module 201 can cause efficiency-of-use module 202 to compute an efficiency-of-use score for the use of product 101A. For example, network module 307 of system 108 can receive information that describes how product 101A was used during the period of time that the user had control of it; such as for example, information that describes the status of product 101A or a portion of product 101A, information that describes if product 101A was damaged, information that describes how much product 101A depleted, i.e., used-up, etc. This information can be routed to efficiency-of-use module 202, which can use it to compute an efficiency-of-use score, e.g., a numerical value such as 1 to 100 where lower numbers indicate a more efficient use or an abstract score such as “good,” “bad,” “average,” etc., from the information and an efficiency-of-use profile for product 101 stored in product profile database 210. For example, a profile for product 101 can be stored in product profile database 210 that can define the ideal-efficient use of product 101. The information that describes how product 101A was used can be compared to the use profile and the score can be calculated. The use-profile for product 101A could then be updated to reflect its current status in the instance that product 101A is depleted (or partially depleted) during the use.

In a specific example, suppose user 300A rents product 101A, which could be an automobile. In this example, an efficiency-of-use score could be computed each time user 300A drives car, at the end of each day, week, month, etc.

Similarly, an efficiency-of-use score can be computed, e.g., calculated, from information that described how product 101B was used during a period of time that a second user 300B has or had control of product 101B. For example, association module 201 can cause efficiency-of-use module 202 to compute an efficiency-of-use score for the use of product 101B. For example, network module 307 of system 108 can receive information that describes how product 101B was used during the period of time that the user had control of it; such as for example, information that describes the status of product 101B or a portion of product 101B, information that describes if product 101B was damaged, information that describes how much product 101B depleted, i.e., used-up, etc. This information can be routed to efficiency-of-use module 202, which can use it to compute an efficiency-of-use score, e.g., a numerical value such as 1 to 100 where lower numbers indicate a more efficient use or an abstract score such as “good,” “bad,” “average,” etc., from the information and an efficiency-of-use profile for product 101B stored in product profile database 210. For example, a profile for product 101B can be stored in product profile database 210 that can define the ideal-efficient use of product 101B. The information that describes how product 101B was used can be compared to the use profile and the score can be calculated. The use-profile for product 101B could then be updated to reflect its current status in the instance that product 101B is depleted (or partially depleted) during the use.

Operation 504 shows comparing the efficiency-of-use score associated with the use of the first physical product by the first user to the efficiency-of-use score associated with the use of the second physical product by the second user. As noted above with respect to operations 504 and 508, efficiency-of-use scores may be computed for use of a product 101 by at least two users 300. Suppose that a ecological service provider 107 (e.g. a rental car company) desired to provide motivation to the users 300 to use the product 101 in an efficient manner. To affect this efficient use, it may be desirable to provide a user 300 feedback regarding the efficiency of their use as compared to other users 300 of the product 101. As such, referring to FIGS. 2-4, each efficiency-of-use score for a given user 300 may be stored in user account database 203 and/or user account database 406. For example, upon completion of a use of the product 101 by a user 300A, the efficiency-of-use score for that use may be computed by the efficiency-of-use module 202 and/or the efficiency-of-use module 405. This efficiency-of-use score of user 300A may be compared by the efficiency-of-use module 405 to a prior efficiency-of-use score by at least one second user (e.g. user 300B and/or user 300C) to determine whether the use by user 300A was more efficient or less efficient than the prior uses by user 300B and/or user 300C. This comparative relationship between the efficiency-of-use scores of user 300A, user 300B and/or user 300C may be stored to the respective user accounts of user 300A, user 300B and/or user 300C user account database 203 and/or user account database 406. For example, if the comparison indicates the use of the product 101 by user 300A is more efficient than the use of the product 101 by user 300B, the user account of user 300A may reflect as such while the user account of user 300B is updated to show a reduced level of relative efficiency associated with their prior use of the product 101.

Operation 506 shows providing a notification according to the comparison of an efficiency-of-use score associated with the use of the first product by the first user to an efficiency-of-use score associated with the use of the second product by the second user. As described above, the efficiency-of-use score of first user 300A may be compared to a prior or contemporaneous efficiency-of-use score for at least one second user (e.g. user 300B and/or user 300C) to determine whether the use by user 300A was more efficient or less efficient than the prior uses by user 300B and/or user 300C. In order to affect efficient use of the product 101, it may be desirable to notify a user 300 users 300 of the efficiency of their use of the product 101 relative to the efficiency of the use of product 101 by other users 300 so that the user 300 may track/modify their behavior relative to the other users 300. As such, following a comparison of the efficiency-of-use score for a user 300 to that of other users 300, a notification of that comparison may be provided to the user 300 so that the user 300 may be made aware of the relative efficiency of their use of the product 101. This notification may be provided in any number of ways.

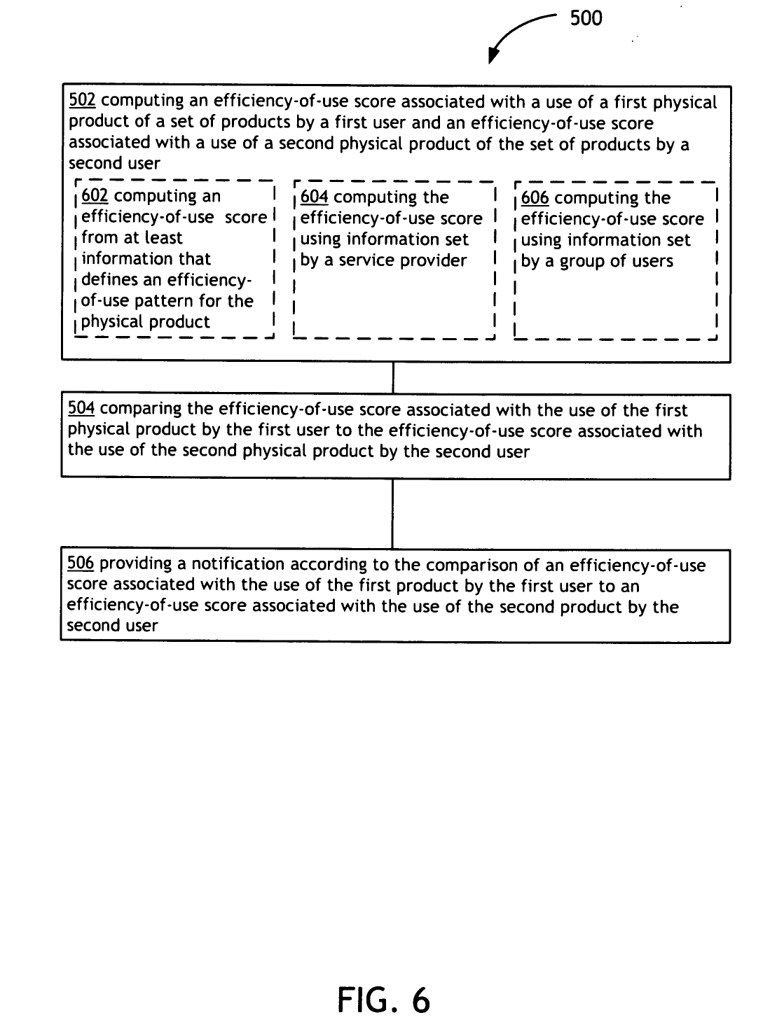

Referring to FIG. 6, FIG. 6 illustrates an example embodiment where operation 502 of the example operational flow 500 of FIG. 5 may include at least one additional operation. Additional operations may include an operation 602, 604 and/or 606.

Operation 602 shows computing an efficiency-of-use score from at least information that defines an efficiency-of-use pattern for a physical product. Referring to FIG. 2, in this exemplary embodiment, efficiency-of-use module 202 can be configured to calculate efficiency-of-use scores from data from one or more categories of data. For example, a category of data for an automobile may be miles driven or average miles per gallon of gasoline. A category used to compute how efficiently a mobile device was used could be energy used over a time period. This data can be compared to one or more use-profiles and a sub-score, e.g., a percentage, for the category can be calculated. In this example, the percentage could reflect how closely the user was to the ideal-efficient use. The sub-score, which reflects how closely the use was to an optimal use in a select category, can be weighted; combined with zero or more other sub-scores; and used to compute an efficiency-of-use score. In a specific example, the sub-scores for each category can be weighted and summed. This value can then be divided by the sum of the weights and normalized to obtain an efficiency-of-use score. One of skill in the art can appreciate that the disclosure is not limited to using this specific type of equation to calculate efficiency-of-use scores and any equation can be used.

Suppose that product 101 is a washing machine located in a self-service laundry facility called a laundromat. In this example, a use-profile for the washing machine in the product profile database 210 could include an efficiency metric that indicates the efficient amount of clothing that should be washed in a single cycle in terms of weight. In this example, suppose the information that describes how the washing machine was used includes the weight of the clothing washed by user 300 in a wash cycle. In this example, efficiency-of-use module 202 could compare the weight of the clothing washed by user to a use-profile for the washing machine and calculate the percentage. The percentage could then be normalized and mapped to a numerical score or an abstract score. For example, the use-profile may indicate that the most efficient weight per wash cycle is 10 pounds and the weight of the clothing washed by user 300 was 8 pounds. The efficiency-of-use module 202 can calculate the percentage and determine that the wash was 20% inefficient (8/10=0.2). The efficiency-of-use module 202 can then map the calculated efficiency percentage to a score, e.g., a score of 1 in the instance that the scale is 0-5, i.e., 0.2*100/20=1 where 20 is a normalizing value.

In another specific example, suppose that the use-profile for the washing machine includes multiple efficiency metrics, e.g., weight and water used. In this example, the use-profile could indicate the efficient amount of weight and water used to wash clothing. In this example, suppose the information that describes how the washing machine was used indicates that 8 pounds of clothing were washed in 21 gallons of water. In this example, the use-profile may indicate that the most efficient weight per wash cycle is 10 pounds and the most efficient amount of water to use per wash is 15 gallons of water. The efficiency-of-use module 202 can calculate the difference and determine that the weight was 20% inefficient and amount of water used was 40% inefficient. The efficiency-of-use module 202 can then apply weights to the two scores, and calculate a score that takes both variables into consideration. For example, if both the weight category and the water category had the same weights (which are 1 in this example), then a score could be calculated to be 1.5, i.e., (((0.2*100)+(0.4*100))/(1+1))/20=1.5, where 20 is a normalizing value.

Operation 604 shows computing an efficiency-of-use score using information set by a service provider. For example, efficiency-of-use standards may be set by ecological service provider 107 for use in computation of an efficiency-of-use score. For example, ecological service provider 107, which could be an entity that controls system 108 such as a rental car company, a rent-to-own company, a neighborhood association, a product owner, etc., can set information, e.g., weights, variables, use-profiles for one or more categories, etc. to affect how efficiency-of-use module 202 computes efficiency-of-use scores. Thus, what it means to “use” product 101 efficiently could be defined by an ecological service provider 107. For example, the information could be used to change the weights used for different sub-scores when efficiency-of-use module 202 computes them. In another example, the information could be a use-profiles for categories of data. For example, product 101 could be a rental product 101 such as a car, a piece of heavy machinery, a TV, etc. In this example, ecological service provider 107 could create an efficiency-of-use profile that takes the interests of the owner into account. The ecological service provider 107 could emphasize certain categories of data over others based on the organization's interest in product 101. For example, in the instance that product 101 is a rental car, ecological service provider 107, e.g., the rental car company, could deemphasized a use profile associated with average miles per gallon of gasoline by using a use profile that defines efficient use more leniently. Exemplary service providers may include, but are not limited to: a rental service renting products 101 (e.g. an cameral rental company); a repair service providing repairs to products 101 (e.g. an appliance repair company); a leasing service leasing products 101 (e.g. an automobile leasing company); and the like.

Operation 606 shows computing an efficiency-of-use score using information set by a group of users. For example, information set by a group of users 300 who are each associable with a product 101 can be used to compute the efficiency-of-use score. For example, a group of users 300 such as a “Green group” can organize itself and create its own use profiles for a product 101. In this example, the users may hold themselves to different standard than a company or the government by setting information, e.g., weights, variables, use-profiles for one or more categories, etc. to affect how efficiency-of-use module 202 computes efficiency-of-use scores to compute scores based on how the use of products directly affect the environment. Here, the users may create a group and add information to product profile database 210 and/or a table of variables and weights that efficiency-of-use module 202 uses when computing scores. When efficiency-of-use module 202 computes scores for the members of the group, it can use the identifier for the user account 204 to locate the information instead of, or in addition to, the standard information, e.g., variables, weights, and/or use profiles. In this regard, a user 300 may receive a plurality of efficiency-of-use scores for his or her use of product 101: a standard score, a score calculated using the user group-defined use profiles, a score calculated from use profiles set by a service provider, etc.

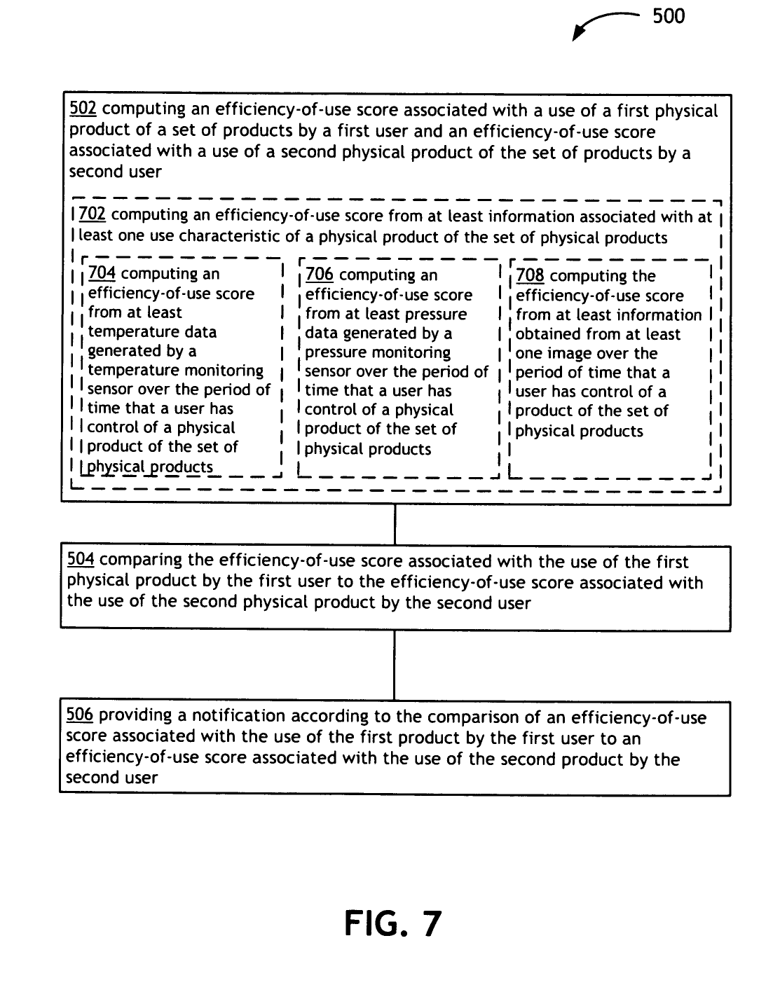

Referring to FIG. 7, FIG. 7 illustrates an example embodiment where operation 502 of the example operational flow 500 of FIG. 5 may include at least one additional operation. Additional operations may include an operation 702, 704, 706 and/or 708.

Operation 702 shows computing an efficiency-of-use score from at least information associated with at least one use characteristic of a physical product of the set of physical products. In another exemplary embodiment, use characteristics of the product 101 can be used to generate a relative score for a use of product 101 by a user 300 based on how other users 300 have used product 101 or a similar product, e.g., another instance of product 101. In this example, efficiency data can be generated for uses of product 101 or a similar product and a use profile can be created over time. In this example, when efficiency-of-use module 202 computes an efficiency-of-use score for use of the product 101 by a current user 300, the user 300 will be judged based on how his or her peer users 300 have used the same or a similar product.

In a specific example, suppose product 101 is an automobile and the use profile is generated over time for miles per gallon of gasoline. In this example, suppose that the automobile, when running efficiently, obtains 33 miles per gallon of gasoline on the highway; however, the average users 300 that operate the vehicle and vehicles of the same make and model obtain 27 miles per gallon. In this example, efficiency-of-use module 202 can be configured to calculate efficiency-of-use scores that use the use profile that reflects that users 300 obtain 27 miles per gallon. Similar to that described above, efficiency-of-use module 202 could compute multiple efficiency-of-use scores for the same user 300: one based on how he or she compares to other users 300, one that is based on how he or she compares to an optimal use of product 101, etc.

Operation 704 shows computing an efficiency-of-use score from at least temperature data generated by a temperature monitoring sensor over the period of time that a user has control of a physical product of the set of physical products. As shown in FIG. 3 and/or FIG. 4, sensor module 302 or sensor module 402 can be a temperature monitoring sensor that can be attached to product 101, a sub-component of product 101 and/or device 309. In this specific example, temperature data can be gathered by the temperature monitoring sensor at least during the period of time that product 101 is associated with a user 300, i.e., during the time product 101 is associated with the user account 204 for user 300 (which could be an hour, a day, a year, etc). In this example, the temperature monitoring sensor can generate temperature data and encode it within a message that could include a field that identifies product 101; the type of data stored in the package (temperature data); and a temperature value. This message can be sent, e.g., via network module 307 attached to product 101, network adapter 410 of device 309 or an adaptor located elsewhere, to network module 109 of system 108. The message including the temperature data can be routed to an efficiency-of-use module 202, which can extract the temperature data and use it by itself or along with data from other categories to compute an efficiency-of-use score.

In a specific example, suppose product 101 is a computing device such as a laptop computer system. In this example, suppose a user 300 uses the laptop computer in a way that causes it to generate large amounts of heat, e.g., the user overclocks the processor or leaves the laptop on instead of in sleep mode. In another specific example, suppose product 101 is an automobile. In this example, the temperature monitoring sensor could be used to determine the operating temperature of the car. In another example, product 101 could be a battery, e.g., a lithium-ion battery. Lithium-ion batteries have a lifespan that is affected by the temperature at which the battery is stored and the state-of-charge of the battery when it is stored. In this example, the temperature monitoring sensor can generate a signal that indicates the temperature of the battery and a message including the temperature can be sent to system 108 and used to generate an efficiency-of-use score.

Operation 706 shows computing an efficiency-of-use score from at least pressure data generated by a pressure monitoring sensor over the period of time that a user has control of a physical product of the set of physical products. As shown in FIG. 3 and/or FIG. 4, sensor module 302 or sensor module 402 can be a pressure monitoring sensor that can be attached to product 101, a sub-component of product 101 and/or device 309. In this specific example, pressure data can be gathered by the pressure monitoring sensor at least during the period of time that product 101 is associated with a user 300, i.e., during the time product 101 is associated with the user account 204 for user 300 (which could be an hour, a day, a year, etc). In this example, the pressure monitoring sensor can generate pressure data and encode it within a message that could include a field that identifies product 101; the type of data stored in the package (pressure data); and a pressure value. This message can be sent, e.g., via network module 307 attached to product 101, network adapter 410 of device 309 or an adaptor located elsewhere, to network module 109 of system 108. The message including the pressure data can be routed to an efficiency-of-use module 202, which can extract the pressure data and use it by itself or along with data from other categories to compute an efficiency-of-use score.

In a specific example, suppose the pressure monitoring sensor is a MEMS sensor that can be placed within a tire, a liquid, e.g., water, oil, etc. In this example, as product 101 is being used, pressure data can e captured and routed to efficiency-of-use module 202. The efficiency-of-use module 202 can then use the data to compute an efficiency-of-use score. For example, suppose product 101 is a tire of a rental car. In this example, the pressure data could indicate that the tire and by extension the car is being stressed, which in turn could cause unreasonable wear-and-tear on one or more components of the vehicle.

Operation 708 shows computing an efficiency-of-use score from at least information obtained from at least one image over the period of time that a user has control of a physical product of the set of the physical products. Referring again to FIG. 2, in an exemplary embodiment, efficiency-of-use module 202 can determine an efficiency-of-use score from at least one image of product 101. For example, and referring to FIG. 4, device 309 may include camera module 411, which could include a video camera and/or a still image camera. In this example, one or more images, e.g., a video and/or a group of one or more pictures, can be generated by camera module 411 and sent to system 108. In a specific example, user 300 who could be the owner of product 101 or an agent of the owner, could use device 309 to generate images of product 101, e.g., images of damage to product 101 and/or a subcomponent of product 101, after user 300 returns it. Returning to FIG. 2, the one or more images can be transferred to system 108 and analyzed by efficiency-of-use module 202, e.g., by comparing the images to images stored in image table 211, and a difference between the images captured and previously stored images can be determined. The difference can be used by efficiency-of-use module 202 to calculate a score. Alternatively, each image showing, for example, damage to product 101 can be noted and the number of images showing damage can be counted. The count could then be used as a factor in determining an efficiency-of-use score.

In another specific example, product 101 can include camera module 306, which can be configured to capture images of one or more subcomponents of product 101. For example, product 101 could be a chainsaw and the camera module 306 can be configured to capture images of the blades in the chainsaw before and after user 300 uses product 101. In this example, the difference between how one or more blades appear in the images can be computed by efficiency-of-use module 202 and quantified. The quantification can then be used by efficiency-of-use module 202 to calculate an efficiency-of-use score. For example, suppose user 300 uses the chainsaw to cut down a tree and in the process damages one or more teeth of the chainsaw. In this example, efficiency-of-use module 202 can determine from one or more images that one or more of the teeth were damaged and compute an efficiency-of-use score that reflects that the chainsaw was used inefficiently, i.e., the user caused great wear-and-tear on product 101.

In another specific example, suppose product 101 is a vehicle that includes camera module 306 configured to take images of a tire. In this example, the difference between how the tread of the tire appears in before and after images can be computed by efficiency-of-use module 202 and quantified. The quantification can then be used by efficiency-of-use module 202 to calculate an efficiency-of-use score. For example, suppose user 300 slams on the breaks of the vehicle and causes large portions of the tire to wear off. In this example, efficiency-of-use module 202 can determine an efficiency-of-use score that reflects that the vehicle was used inefficiently.

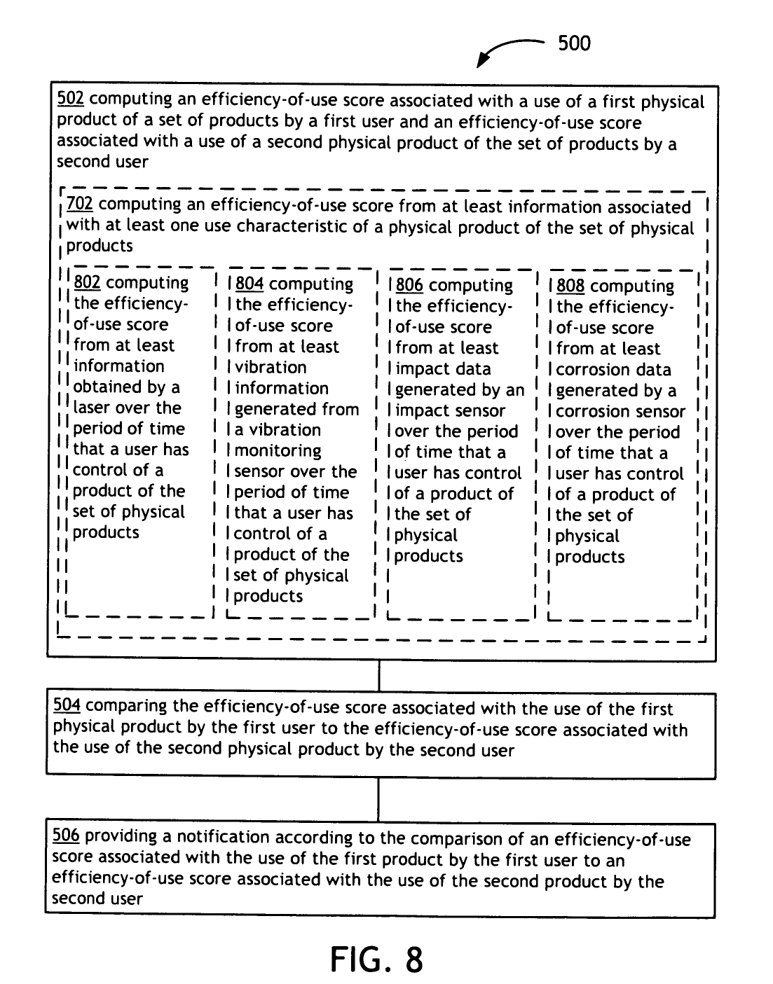

Referring to FIG. 8, FIG. 8 illustrates an example embodiment where operation 702 of the example operational flow 500 of FIG. 7 may include at least one additional operation. Additional operations may include an operation 802, 804, 806 and/or 808.

Operation 802 shows computing an efficiency-of-use score from at least information obtained by a laser over the period of time that a user has control of a physical product of the set of the physical products. Referring now to FIG. 3 and/or FIG. 4, sensor module 302 or sensor module 402 can be a laser module that can be attached to product 101, a sub-component of product 101 and/or a device 309. In this specific example, rotational information, e.g., from a ring laser gyroscope, dimensional measurements, e.g., distance, thickness, etc. can be gathered by the laser sensor at least during the period of time that product 101 is associated with a user 300, i.e., during the time product 101 is associated with the user account for user 300. In this example, the laser module can generate data and encode it within a message that could include a field that identifies product 101 and user account 204; the type of data stored in the message; and the data. This message can be sent to network module 109 of system 108. The message can be routed to efficiency-of-use module 202, which can extract the data and use it to compute an efficiency-of-use score.

In a specific example, suppose product 101 is a set of breaks within an automobile. In this example, the laser module may be installed within the automobile so that it can reflect a laser beam off the brake pads and determine thickness information. After a user 300 uses the automobile, the laser module can again gather information that indicates how thick the brake pads are and send the information to system 108, which could be located at a rental company, or store the information for extraction by an agent of the rental car company. The information can be routed to the efficiency-of-use module 202 and used to calculate an efficiency-of-use score that takes into account the amount of wear that was placed on the breaks relative to an amount that constitutes an efficient use of the breaks.

Operation 804 shows computing an efficiency-of-use score from at least vibration information generated from a vibration monitoring sensor over the period of time that a user has control of a physical product of the set of the physical products. Again turning to FIG. 3 or 4, sensor module 302 associated with product 101 and/or sensor module 402 of device 309 can be a vibration monitoring sensor, e.g., a piezoelectric sensor. In this exemplary embodiment, the vibration monitoring sensor could be installed within a machine such a skid loader, e.g., a Bobcat®, to monitor vibration associated with one or more internal mechanical parts. As product 101 is used, the vibration monitoring sensor can generate vibration information and either send the information to system 108 or store it for later extraction. The efficiency-of-use module 202 can receive the vibration data and compare it to a profile for product 101 stored in product profile database 210. The efficiency-of-use module 202 can then use the difference to compute an efficiency-of-use score for the use of product 101 by user 300.

For example, internal components vibrate differently when under different amounts of stress. For example, a refrigerator's internal cooling machinery may vibrate when cooling the refrigerator. A situation where the internal cooling machinery is operating for long periods of time can be indicative of inefficient use of the refrigerator, e.g., the temperature is set too low. In another example, the vibration monitoring sensor could be placed relative to an engine in a vehicle, e.g., automobile, boat, etc. In this example, a vibration profile could be created for the engine that reflects efficient operation of the engine. As the stress on the engine changes it may vibrate differently and the vibration sensor can generate an electrical signal indicative of how the engine is vibrating and send it to efficiency-of-use module 202, which can use the difference between the profile and how the engine is or was vibrating to calculate an efficiency-of-use score.

Operation 806 shows computing an efficiency-of-use score from at least impact data generated by an impact sensor over the period of time that a user has control of a physical product of the set of the physical products. For example, and again turning to FIG. 3 or 4, sensor module 302 associated with product 101 and/or sensor module 402 of device 309 can be an impact sensor module, e.g., a piezoelectric sensor. In this exemplary embodiment, the impact monitoring sensor could be installed within a device such as a laptop to monitor whether the laptop is dropped or deformed by an outside force. As product 101 is associated with user 300, the impact monitoring sensor can generate impact information either record it (within memory) or send it to system 108. The efficiency-of-use module 202 can receive the impact data and compare it to a profile for product 101 stored in product profile database 210. The efficiency-of-use module 202 can compute an efficiency-of-use score for the use of product 101 by user 300. In a specific example, if the user drops the laptop or smashes it by placing heavy books on it, the impact sensor module can generate an electrical signal indicative of the impact and the electrical signal can be communicated to efficiency-of-use module 202. The efficiency-of-use module 202 can then use this information to compute an efficiency-of-use score that reflects that the laptop was inefficiently used, e.g., it was smashed, dropped, etc.

Operation 808 shows computing an efficiency-of-use score from at least corrosion data generated by a corrosion sensor over the period of time that a user has control of a physical product of the set of the physical products. For example, and again turning to FIG. 3 or 4, sensor module 302 associated with product 101 and/or sensor module 402 of device 309 can be an corrosion sensor module that measures the extent of rust and corrosion on product 101. In this exemplary embodiment, the corrosion sensor could be installed within a device that is exposed to weather, e.g., a lawn mower, a vehicle, a device used to cook food (e.g. an oven or grill), etc. While product 101 is associated with user 300, the corrosion sensor module can generate an electrical signal based on the amount of corrosion detected on product 101 and either record it (within memory) or send it to system 108. The efficiency-of-use module 202 can receive the electrical signal data and compare it to a profile for product 101 stored in product profile database 210. The efficiency-of-use module 202 can then compute an efficiency-of-use score for the use of product 101.

In a specific example, suppose user 300 borrows a lawn mower and then leaves it outside overnight prior to returning it to his neighborhood association. In this example, suppose an agent of the neighborhood association checks the lawn mower back in and uses device 309, which could include a corrosion sensor, to scan the lawn mower. In this example, the agent could receive a signal indicative of how much corrosion occurred and use this along with a corrosion profile for the lawn mower to compute an efficiency-of-use score that takes corrosion that was caused by the inefficient use of product 101 in account.

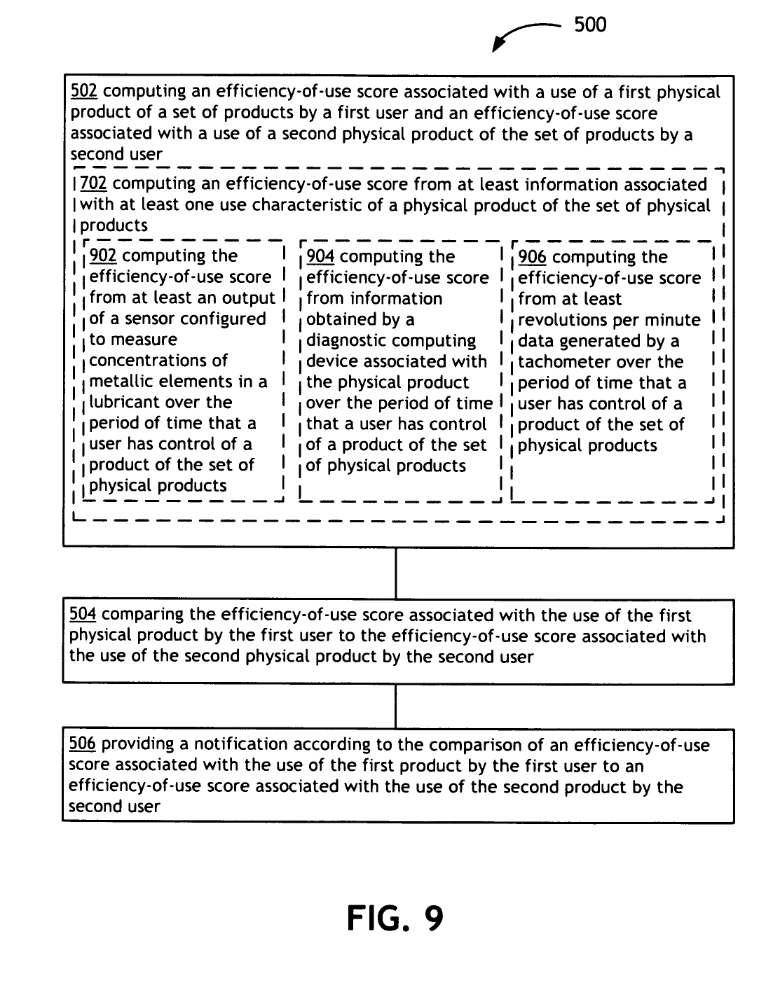

Referring to FIG. 9, FIG. 9 illustrates an example embodiment where the operation 702 example operational flow 500 of FIG. 7 may include at least one additional operation. Additional operations may include an operation 902, 904 and/or 906.

Operation 902 shows computing an efficiency-of-use score from at least an output of a sensor configured to measure concentrations of metallic elements in a lubricant over the period of time that a user has control of a physical product of the set of the physical products. For example, and again turning to FIG. 3 or 4, sensor module 302 associated with product 101 and/or sensor module 402 of device 309 can be a sensor module that measures the amount of metallic elements that are present within a lubricant employed in product 101. An important function of lubricant is to improve or enhance the friction and wear characteristics of surfaces in relative motion. For example, internal combustion engines require chemically formulated lubricants to provide operational efficiency and durability. The use of lubricants in this application, not only reduces friction and wear, but controls the accumulation of unwanted deposits derived from the combustion process, as well as dissipating heat. In this exemplary embodiment, the sensor could be installed within a tank component of product 101 that contains a lubricant (e.g. motor oil) and can be configured to monitor the amount of waste materials (e.g. metallic elements) that accumulate within the lubricant. While product 101 is associated with user 300, the sensor module can generate an electrical signal based on the amount of waste materials detected in the lubricant and either record it (within memory) or send it to system 108. The efficiency-of-use module 202 can receive the electrical signal data and compute an efficiency-of-use score for the use of product 101 that takes at least this factor into account.

In a specific example, suppose the product 101 is an automobile that a user 300 leases for an extended period of time, but fails to regularly change the oil. In this example, suppose the automobile includes a sensor (e.g. a capacitive concentration sensor) to monitor one or more lubricants and generates an electrical signal indicating that the oil is polluted, which causes the automobile to operate inefficiently. In this example, the sensor module 302 can generate a value based on the pollution within the lubricant and send a signal, which can eventually be routed to efficiency-of-use module 202. The efficiency-of-use module 202 can compute an efficiency-of-use score that is based at least in part on the inefficient use of the automobile.

Operation 904 shows computing an efficiency-of-use score from information obtained by a diagnostic computing device associated with the physical product over the period of time that a user has control of a physical product of the set of the physical products. For example, and again turning to FIG. 3 or 4, sensor module 302 associated with product 101 and/or sensor module 402 of device 309 can include a diagnostic computing device, e.g., a microprocessor configured to monitor one or more operating parameters of product 101. For example, product 101 which could be an automobile, computer system, i.e., a web-server, a personal laptop computer, a videogame console, etc., can include a microprocessor configured to receive input from various sensors and control product 101. In a specific example, product 101 can be an automobile and the diagnostic computing device could be the onboard computer. In this example, the onboard computer could control the air/fuel mixture, manage emissions and fuel economy; temperature of the coolant; deployment of the airbag, whether the anti-lock brakes are deployed, etc. Similarly, in a web-server the diagnostic computing device could be a module of executable code that monitors the speed the CPU fans are operating at, the temperature of the CPU, and operating system characteristics such as the amount of available random access memory, the number of page faults, etc. The diagnostic computing device could also be an external computing device that can be connected (wirelessly or physically) to one or more components of product 101. In a specific example, diagnostic computing device could be a handheld battery testing device that can check the status of an automobile's battery and electrical system. Diagnostic computer device can then gather information about product 101, i.e., about one or more components of product 101. In this exemplary embodiment, the data generated by the diagnostic computing device can be recorded or sent it to system 108. The efficiency-of-use module 202 can receive the electrical signal data and compute an efficiency-of-use score for the use of product 101 that takes at least some of this information into account.

Operation 906 shows computing an efficiency-of-use score from at least revolutions per minute data generated by a tachometer over the period of time that a user has control of a physical product of the set of the physical products. For example, and again turning to FIG. 3 or 4, sensor module 302 associated with product 101 and/or sensor module 402 of device 309 can be a sensor module that measures revolutions per minute data of, for example, an engine of an automobile. In this example, a sensor module operatively coupled to the engine can generate an electrical signal indicative of the rate of revolution of the engine and either record it (within memory, e.g., RAM, ROM, etc.) or send it to system 108. The efficiency-of-use module 202 can receive the electrical signal data and compute an efficiency-of-use score for the use of product 101 that takes at least this factor into account. For example, the average revolutions per minute can indicate how hard the engine was working over a period of time, e.g., a minute, an hour, or during a trip, i.e., from when the car is turned on until it is turned off. This information in turn can be used to calculate how efficiently the automobile was used. For example, an automobile associated with high RPM data could be indicative of inefficient use.

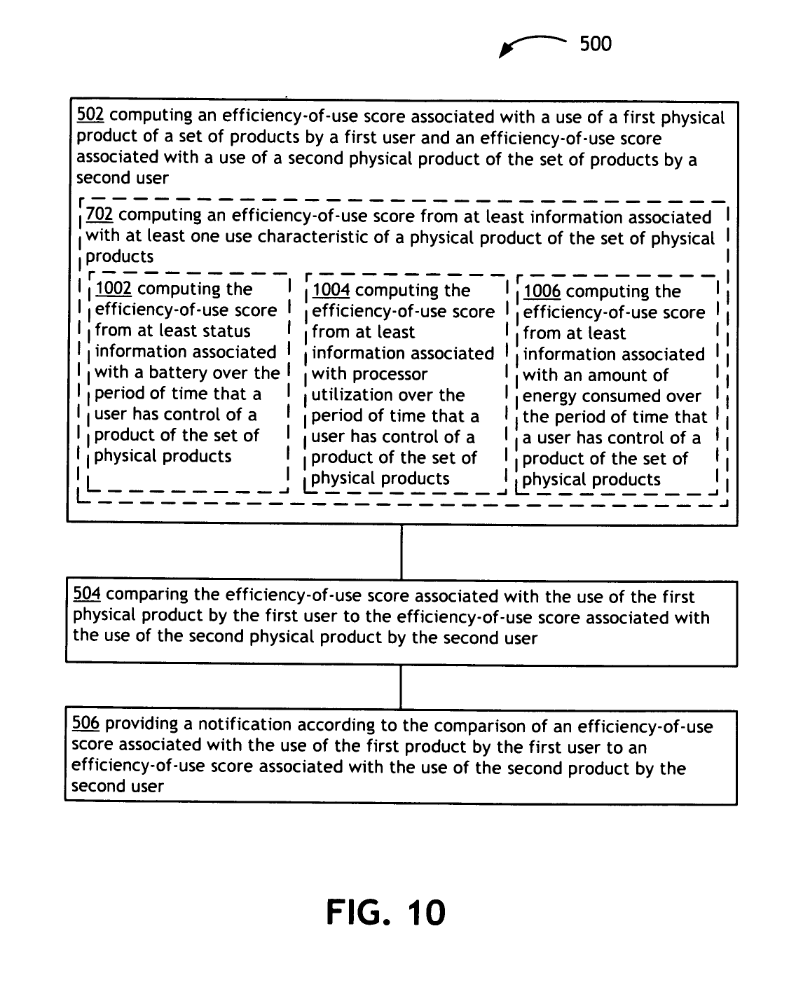

Referring to FIG. 10, FIG. 10 illustrates an example embodiment where operation 702 of the example operational flow 500 of FIG. 7 may include at least one additional operation. Additional operations may include an operation 1002, 1004 and/or 1006.

Operation 1002 shows computing an efficiency-of-use score from at least status information associated with a battery over the period of time that a user has control of a physical product of the set of the physical products. For example, and again turning to FIG. 3 or 4, sensor module 302 associated with product 101 and/or sensor module 402 of device 309 can be a sensor module that measures battery data, e.g., the number of times that the battery was discharged, the percentage of battery charge that was discharged prior to it being recharged, operating temperature of the battery, etc. In a specific example, the battery could be a battery used to supply energy to a laptop, hybrid automobile, or a mobile device. The life of a battery is determined by the number of cycles it has to perform and the depth of the discharge. For example, a lithium-ion battery may provide 300-500 discharge/charge cycles. In addition, the life of the battery can be affected by discharging all or a portion of the battery prior to recharging it. For example, it is preferable to partially discharge the battery than to fully discharge it. In general, the optimum life to utility ratio may occur if the battery is not discharged lower than 40˜50 percent for certain types of batteries, e.g., certain types of lithium-ion battery.

In an exemplary embodiment where status information of the battery is used to calculate an efficiency-of-use score, the sensor can be operatively coupled to the battery and can track the number of charge cycles and/or the amount of charge that is discharged and either record it (within memory, e.g., RAM, ROM, etc.) or send it to system 108. The efficiency-of-use module 202 can receive the battery status data and compute an efficiency-of-use score for the use of product 101 that takes at least this category of data into account. For example, the if user 300 uses product 101, e.g., a laptop and discharges the battery to 20% prior to charging it, a message including information such as an identifier for the user account for user; the type of data stored in the message; and the battery charge percentage can be generated and sent to system 108. In this example, efficiency-of-use module 202 can use the information that indicates that the battery was discharged down to 20% prior to it was recharged and compute an efficiency-of-use score that reflects how efficiently user 300 used the laptop.

Operation 1004 shows computing an efficiency-of-use score from at least information associated with processor utilization over the period of time that a user has control of a physical product of the set of the physical products. For example, and again turning to FIG. 3 or 4, sensor module 302 associated with product 101 and/or sensor module 402 of device 309 can be a sensor module that measures how much a processor was used during a time period of interest, e.g., during the time period that product 101 is associated with the user account 204 for user 300. Processor power consumption is closely connected with clock frequency and overclocking increases the system performance at the expense of energy efficiency. Moreover, central processing units that have multiple execution cores use more energy and different types of workloads can cause central processing units to use more energy. In this example, the CPU can execute a program that can store usage data and either record it (within memory, e.g., RAM, ROM, etc.) or cause it to be sent to system 108. The efficiency-of-use module 202 can receive the data and compute an efficiency-of-use score for the use of product 101 that takes at least this factor into account.

In a specific example, suppose user 300 logs into a computer system located at a library and starts watching a high-definition movie. In this example, suppose the playing of the movie causes the central processing unit to operate at near maximum capacity and in turn causes it to consume large amounts of energy of a long period of time. In this example, a program running on the computer system can record the CPU utilization information while user 300 is playing the movie and cause a message to be sent to system 108, which in this example could be a computer system within the library that maintains user accounts for people who visit and use the services of the library. The efficiency-of-use module 202 can receive the message and any other messages associated with the user account, and compute an efficiency-of-use score that at least takes CPU utilization into account.

Operation 1006 shows computing an efficiency-of-use score from at least information associated with an amount of energy consumed over the period of time that a user has control of a physical product of the set of the physical products. For example, and again turning to FIG. 3 or 4, sensor module 302 associated with product 101 and/or sensor module 402 of device 309 can be a sensor module that measures how much energy product 101 uses when, for example, it is associated with the user account 204 for user 300, i.e., for a brief period of time, e.g., while user 300 rents or borrows product 101, or a longer period of time, e.g., the period of time that user owns product 101 or a portion thereof. In this example, the amount of energy product 101 uses can be used to determine how efficiently it is being used. For example, product 101 can be associated with an energy profile, which describes an efficient amount of energy for product 101 to use over a period of time, e.g., a minute, hour, day, week, etc. In this example, the amount of energy product 101 over the measuring period of time can be tracked and used to compute an efficiency-of-use score.

Suppose product 101 is a high definition plasma TV. In this example, suppose the TV includes a sensor module that measures how much energy is consumed by the TV. For example, the sensor module could be placed within the circuit that interfaces the TV with an electrical outlet. In this example, the sensor module can record how much energy the TV consumes and send the information to system 108, which could be maintained by the government, a “Green organization,” or the user, i.e., system 108 could be a home computer system. Suppose in this example that user 300 has left the TV on for that past two days while he or she was away from home. In this example, at the end of each day the sensor module could send how much energy it has consumed to system 108. The efficiency-of-use module 202 can receive the information and compare it to a use profile that includes information that indicates normal use of the TV. The efficiency-of-use module 202 can use the profile and the information from sensor to compute an efficiency-of-use score that reflects that the user has inefficiently used the TV by leaving it on for two full days.

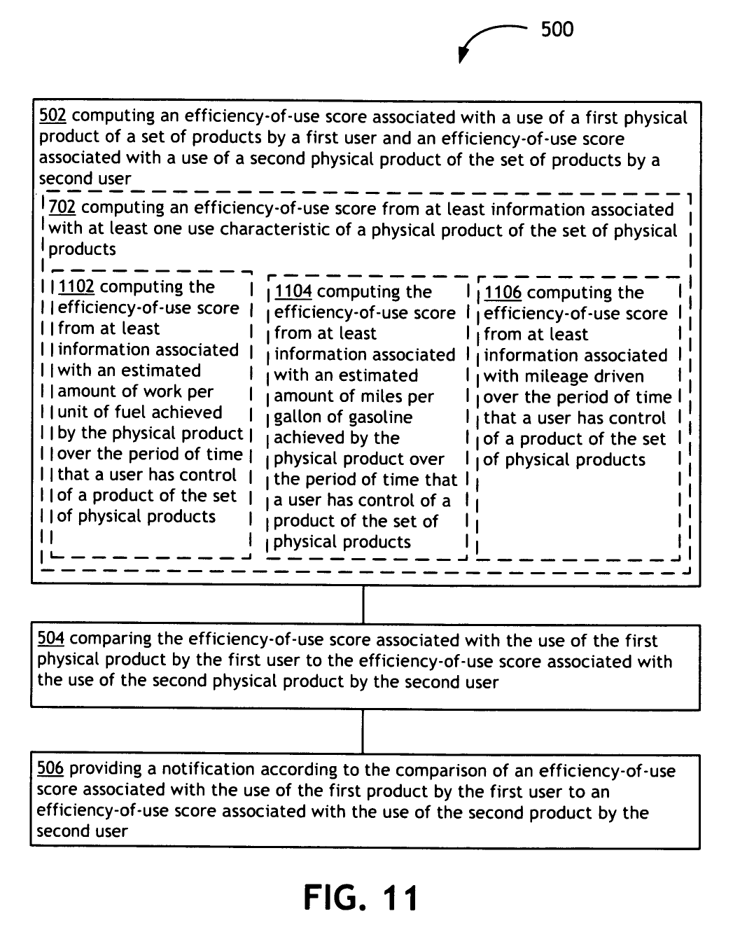

Referring to FIG. 11, FIG. 11 illustrates an example embodiment where operation 702 of the example operational flow 500 of FIG. 7 may include at least one additional operation. Additional operations may include an operation 1102, 1104 and/or 1106.

Operation 1102 shows computing an efficiency-of-use score from at least information associated with an estimated amount of work per unit of fuel achieved by the physical product over the period of time that a user has control of a physical product of the set of the physical products. For example, and again turning to FIG. 3 or 4, sensor module 302 associated with product 101 and/or sensor module 402 of device 309 can be a sensor module that measures how much work per unit of fuel consumed product 101 has done when, for example, it is associated with the user account for user 300, i.e., for a brief period of time, e.g., while user 300 rents or borrows product 101, or a longer period of time, e.g., the time period that user 300 owns product 101 or a portion thereof. In this example, the amount of work done per unit of fuel, i.e., its fuel efficiency, can be used to determine how efficiently it is being used. For example, the fuel efficiency of product 101 could the amount of operating time a cellular phone achieves per charge of a battery, i.e., the fuel in this example would be the energy charge stored in the battery. In another example, the fuel efficiency of product 101 could be the number of miles driven per gallon of bio-diesel fuel.

Similar to the foregoing examples, product 101 can be associated with fuel efficiency profile, which describes an efficient amount of work achieved per unit of fuel. In this example, a sensor can be incorporated into product 101, e.g., a module of executable instructions running on a cellular phone can compute the total amount of time it has been in operation since its last charge, which can compute the fuel efficiency of product 101 and send the information to system 108, e.g., a computer system controlled by user, the cellular phone company, the electric company, etc., and used to compute an efficiency-of-use score.

Operation 1104 shows computing an efficiency-of-use score from at least information associated with an estimated amount of miles per gallon of gasoline achieved by the physical product over the period of time that a user has control of a physical product of the set of the physical products. For example, and turning to FIG. 3, in an exemplary embodiment product 101 can be a vehicle that operates on gasoline such as a car, a boat, a plane, etc. In this example, sensor module 302 associated with product 101 could be an odometer capable of estimating the miles per gallon of gasoline that the vehicle achieved during the time period that it was controlled by user 300. For example, the time period could cover the time it took user 300 to use the vehicle to drive downtown to pick his or her spouse up from work and drive home. Upon arrival at home, the miles per gallon of gasoline data can be sent in a message to system 108. For example, the vehicle itself could sent the data or an external device can, e.g., device 309. The efficiency-of-use module 202 of FIG. 2 can receive the message; extract the data; and compute an efficiency-of-use score for the trip that takes into account the miles per gallon of gas achieved for the trip.

Operation 1106 shows computing an efficiency-of-use score from at least information associated with mileage driven over the period of time that a user has control of a physical product of the set of the physical products. For example, and again referring to FIG. 3 and/or FIG. 4, suppose product 101 is a vehicle. In this example, a sensor module 302 associated with product 101 and/or sensor module 402 of device 309 could be a GPS module, an odometer, etc., that can record the amount of miles driven per trip. In this example, the mileage the vehicle was driven can be used to determine how efficiently it is being used or was used. For example, product 101 can be associated with a profile, which describes an efficient number miles driven per trip that is set by the owner of the vehicle, a group of friends, the government, etc. In this example, the amount of miles product 101 is driven can be tracked and used to compute an efficiency-of-use score. In a specific example, the profile could indicate that short trips of less than 3 miles are inefficient uses of automobiles. In this example, if a user were to drive his or her car down the block to run an errand he or she can be penalized for wasting resources by receiving a bad efficiency-of-use score.

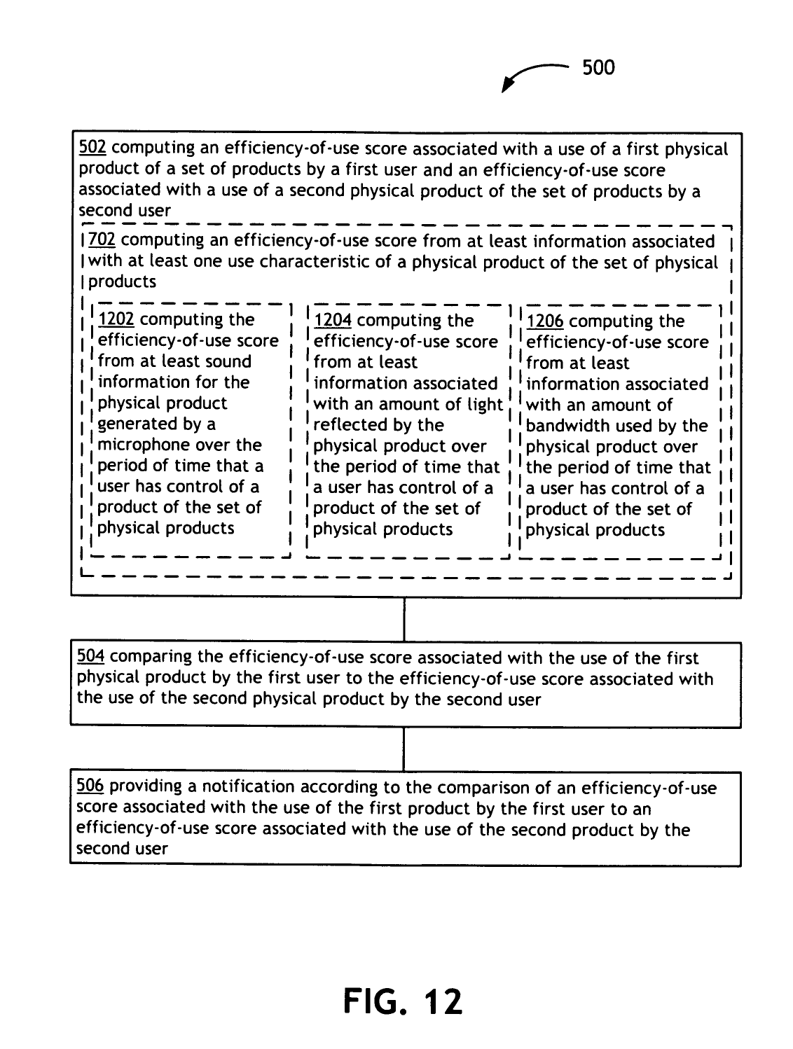

Referring to FIG. 12, FIG. 12 illustrates an example embodiment where operation 702 of the example operational flow 500 of FIG. 7 may include at least one additional operation. Additional operations may include an operation 1202, 1204 and/or 1206.

Operation 1202 shows computing an efficiency-of-use score from at least sound information for the physical product generated by a microphone over the period of time that a user has control of a physical product of the set of the physical products. For example, and again turning to FIG. 3 or 4, sensor module 302 associated with product 101 and/or sensor module 402 of device 309 can be a sensor module that includes a microphone and is configured to detect sounds made by internal components of product 101, e.g., motor bearings, fans, etc. In this example, the sounds made by internal components as they wear out can be used to compute an efficiency-of-use score. For example, as product 101 ages the components may wear and start to generate noises. This information can be captured by the microphone and sent to system 108 and used to generate an efficiency-of-use score. In a specific example, breaks of an automobile begin to squeak at the end of their service life. Continued use of product 101 with worn out components (such as breaks) is inefficient and potentially dangerous. In this exemplary embodiment, use of a product with worn out components can be used to affect an efficiency-of-use score.

Operation 1204 shows computing an efficiency-of-use score from at least information associated with an amount of light reflected by the physical product over the period of time that a user has control of a physical product of the set of the physical products. Referring now to FIG. 3 and/or FIG. 4, sensor module 302 associated with product 101 and/or sensor module 402 of device 309 can be a sensor module that measures light (e.g., infrared light, etc.) reflected off product 101 or a sub-component of product 101. In this specific example, the sensor module can use the amount of light that is reflected off a component to determine how efficiently product 101 was used during the period of time that product 101 is controlled by user 300, i.e., during the time product 101 is associated with the user account for user 300. In this example, the sensor module can generate data and encode it within a message that could include a field that identifies product 101; the type of data stored in the message; and the data. This message can be sent to network module 109 of system 108. The message can be routed to efficiency-of-use module 202, which can extract the data and use it to compute an efficiency-of-use score.

In a specific example, suppose product 101 is a blender located in product usage location 104, which could be a communal kitchen area of an apartment building or dormitory. In this example, suppose the laser module is installed within the blender so that it can reflect a laser beam off the blades of the blender. In this example, the laser module can determine how much light reflects off the blades and store the information. After user 300 uses the blender, the laser module can again gather information that indicates how much light is reflecting off the blades and send the information that reflects how much light reflected off the blades before and after the user used the blender to system 108. The information can be routed to the efficiency-of-use module 202; and used to calculate an efficiency-of-use score. Alternatively, instead of sending the before and after laser information, the blender may transmit the laser information gathered after the use; compare it to a use profile stored in product profile database 210; calculate an efficiency-of-use score; and update the profile for the blender to reflect the current state of it.

Operation 1206 shows computing an efficiency-of-use score from at least information associated with an amount of bandwidth used by the physical product over the period of time that a user has control of a physical product of the set of physical products. For example, and again referring to FIG. 3 and/or FIG. 4, sensor module 302 associated with product 101 and/or sensor module 402 of device 309 can be a sensor module, e.g., a program running within a computing device such as a mobile phone, desktop computer system, etc., that records the amount of bandwidth used by product 101. For example, the amount of bandwidth, e.g., network bandwidth, used by product 101 can be tracked during a period of time that it is associated with a user account for user 300, i.e., a brief period of time, e.g., while user 300 rents or borrows product 101, or a longer period of time, e.g., the period of time that user owns product 101 or a portion thereof. In this example, the amount of bandwidth product 101 uses can be used to determine how efficiently it is being used. For example, product 101 can be associated with a profile, which describes an efficient amount of bandwidth for product 101 to use over a period of time, e.g., a minute, hour, day, week, etc. The profile can be set by the network provider, a group of friends, etc. In this example, the amount of bandwidth product 101 uses over the measuring period of time can be tracked and used to compute an efficiency-of-use score.

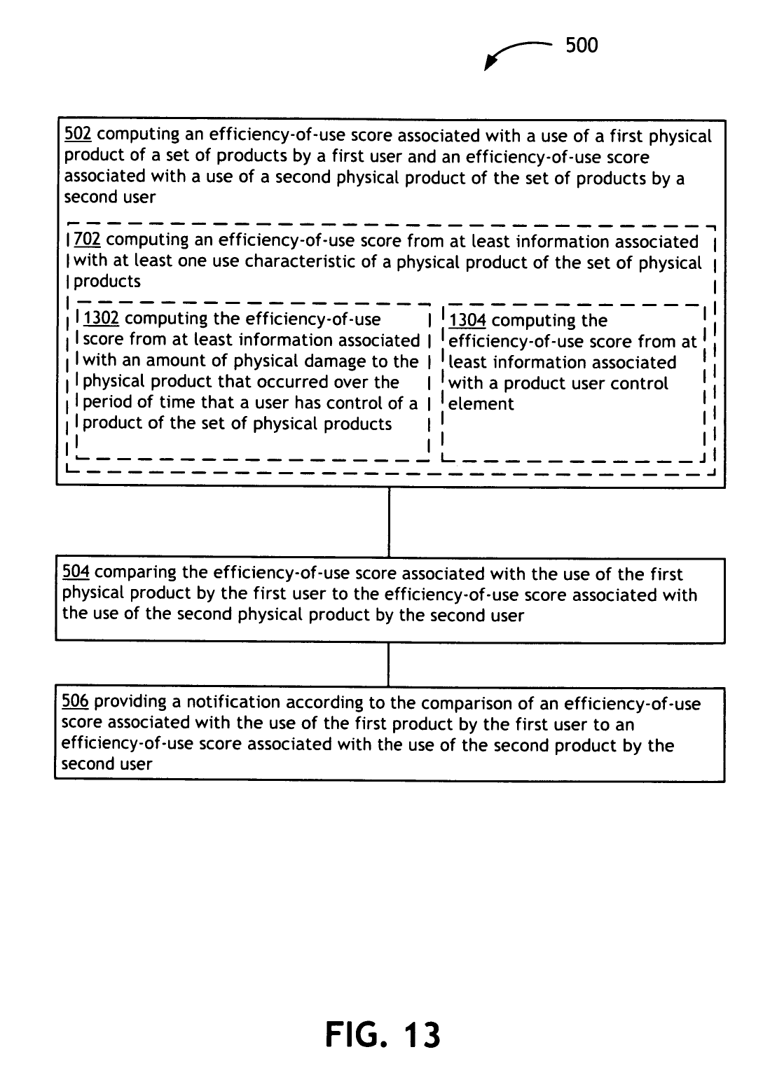

Referring to FIG. 13, FIG. 13 illustrates an example embodiment where operation 702 of the example operational flow 500 of FIG. 7 may include at least one additional operation. Additional operations may include an operation 1302 and/or 1304.

Operation 1302 shows computing an efficiency-of-use score from at least information associated with an amount of physical damage to the physical product that occurred over the period of time that a user has control of a physical product of the set of physical products. Turning back to FIG. 3 and/or FIG. 4, sensor module 302 associated with product 101 and/or sensor module 402 of device 309 can be a sensor module can be attached to product 101, a sub-component of product 101 and/or device 309, that is configured to identify the amount of damage that was caused to product 101 while it was associated with the user account for user 300. For example, the sensor module could be an accelerometer, which could detect sudden decoration which could be indicative of impact. In another embodiment, the sensor module could include an onboard computing device such as a car-computer. In this example, the computer could detect deployment of air bags or if the anti-lock brakes were engaged. In yet another specific example, the information could be captured by an agent during a visual inspection of product 101. For example, the agent could input information that describes the damage done to vehicle into device 309. Any or all of the aforementioned information can be captured and encoded within a message that could include a field that identifies product 101; the type(s) of data stored in the message; and the data. This message can be sent, e.g., via an adaptor attached to product 101 or an adaptor attached to mobile device 309, to network module 109 of system 108. The message can be routed to efficiency-of-use module 206, which can extract the data and use it to compute an efficiency-of-use score.

Operation 1304 shows computing an efficiency-of-use score from at least information associated with a product control element. For example, and again turning to FIG. 3 or 4, sensor module 302 associated with product 101 and/or sensor module 402 of device 309 can be a sensor module that measures a relative position of a user control element (e.g. a throttle, accelerator, steering mechanism, brake pedal, etc.) of the product 101. In this example, a sensor module operatively coupled to the user control element can generate an electrical signal indicative of the position of the user control element (e.g. in a “high” or “low” throttle position) and either record it (within memory, e.g., RAM, ROM, etc.) or send it to system 108. The efficiency-of-use module 202 can receive the electrical signal data and compute an efficiency-of-use score for the use of product 101 that takes at least the user control element into account. For example, a throttle position can indicate how hard a engine of a snow blower was working over a period of time, e.g., a minute, an hour, or during a trip, i.e., from when the snow blower is turned on until it is turned off. This information in turn can be used to calculate how efficiently the snow blower was used. For example, an snow blower associated with high throttle position data could be indicative of inefficient use.

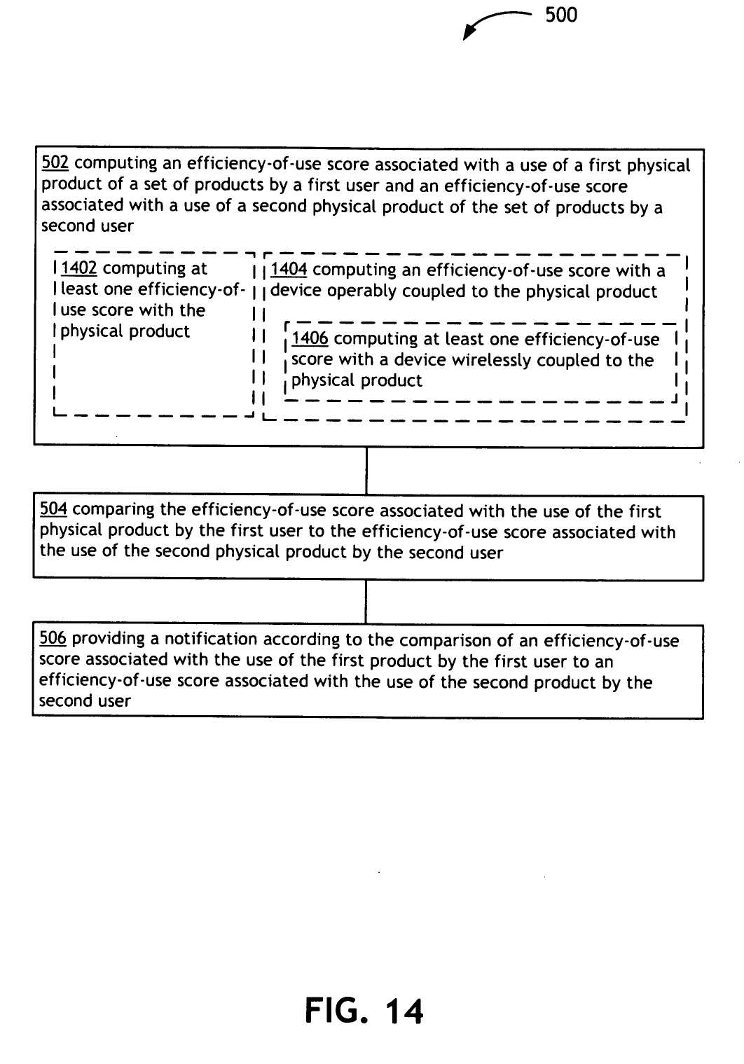

Referring to FIG. 14, FIG. 14 illustrates an example embodiment where the example operational flow 500 of FIG. 5 may include at least one additional operation. Additional operations may include an operation 1402, 1404 and/or 1406.

Operation 1402 shows computing at least one efficiency-of-use score with the physical product. Turning again back to FIGS. 1-4, an efficiency-of-use score can be computed, e.g., calculated, from information that described how product 101 was used during a period of time that a user 300 has or had control of product 101. As noted above, product 101 may include various processing capabilities (e.g. hardware, embedded firmware, software, etc.) for computing the efficiency-of-use score on the product 101, itself. For example, association module 201 of product 101 can cause efficiency-of-use module 202 of product 101 to compute an efficiency-of-use score for the use of product 101 by a user 300. For example, sensor module 302 may provide information that describes how product 101 was used during the period of time that the user had control of it; such as for example, information that describes the status of product 101 or a portion of product 101, information that describes if product 101 was damaged, information that describes how much product 101 depleted, i.e., used-up, etc. This information can be routed to efficiency-of-use module 202 of the product 101, which can use it to compute an efficiency-of-use score, e.g., a numerical value such as 1 to 100 where lower numbers indicate a more efficient use or an abstract score such as “good,” “bad,” “average,” etc., from the information and an efficiency-of-use profile for product 101 stored in product profile database 210 of the product 101. For example, a profile for product 101 can be stored in product profile database 210 of product 101 that can define the ideal-efficient use of product 101. The information that describes how product 101 was used can be compared to the use profile and the score can be calculated. The use-profile for product 101 could then be updated to reflect its current status in the instance that product 101 is depleted (or partially depleted) during the use.

Operation 1404 shows computing an efficiency-of-use score with a device operably coupled to the physical product. Turning again back to FIGS. 1-4, an efficiency-of-use score can be computed, e.g., calculated, from information that described how product 101 was used during a period of time that a user 300 has or had control of product 101. As noted above, product 101 may be operably coupled to a device 309 (e.g. a smart phone, dedicated diagnostic device, monitoring system, etc.) The device 309 may include various processing capabilities (e.g. hardware, embedded firmware, software, etc.) for computing the efficiency-of-use score on the product 101, itself. For example, association module 403 of device 309 can cause efficiency-of-use module 405 of device 309 to compute an efficiency-of-use score for the use of product 101 by a user 300. For example, sensor module 302 and/or sensor module 402 may provide information that describes how product 101 was used during the period of time that the user 300 had control of it; such as for example, information that describes the status of product 101 or a portion of product 101, information that describes if product 101 was damaged, information that describes how much product 101 depleted, i.e., used-up, etc. This information can be routed to efficiency-of-use module 405 of the device 309, which can use it to compute an efficiency-of-use score, e.g., a numerical value such as 1 to 100 where lower numbers indicate a more efficient use or an abstract score such as “good,” “bad,” “average,” etc., from the information and an efficiency-of-use profile for product 101 stored in product profile database 407 of the device 309. For example, a profile for product 101 can be stored in product profile database 407 of device 309 that can define the ideal-efficient use of product 101. The information that describes how product 101 was used can be compared to the use profile and the score can be calculated. The use-profile for product 101 could then be updated to reflect its current status in the instance that product 101 is depleted (or partially depleted) during the use.

Operation 1406 shows computing at least one efficiency-of-use score with a device wirelessly coupled to a physical product of the set of physical products. Turning again back to FIGS. 1-4, an efficiency-of-use score can be computed, e.g., calculated, from information that described how product 101 was used during a period of time that a user 300 has or had control of product 101. As noted above, product 101 may be wirelessly coupled (e.g. via a Bluetooth, Wifi, WiMax, and/or LTE wireless connection) to a device 309 (e.g. a smart phone, dedicated diagnostic device, monitoring system, etc.) The device 309 may include various processing capabilities (e.g. hardware, embedded firmware, software, etc.) for computing the efficiency-of-use score on the product 101, itself. For example, association module 403 of device 309 can cause efficiency-of-use module 405 of device 309 to compute an efficiency-of-use score for the use of product 101 by a user 300. For example, sensor module 302 of product 101 may provide information that describes how product 101 was used during the period of time that the user 300 had control of it to the device 309 over the wireless connection; such as for example, information that describes the status of product 101 or a portion of product 101, information that describes if product 101 was damaged, information that describes how much product 101 depleted, i.e., used-up, etc. This information can be routed to efficiency-of-use module 405 of the device 309, which can use it to compute an efficiency-of-use score, e.g., a numerical value such as 1 to 100 where lower numbers indicate a more efficient use or an abstract score such as “good,” “bad,” “average,” etc., from the information and an efficiency-of-use profile for product 101 stored in product profile database 407 of the device 309. For example, a profile for product 101 can be stored in product profile database 407 of device 309 that can define the ideal-efficient use of product 101. The information that describes how product 101 was used can be compared to the use profile and the score can be calculated. The use-profile for product 101 could then be updated to reflect its current status in the instance that product 101 is depleted (or partially depleted) during the use.

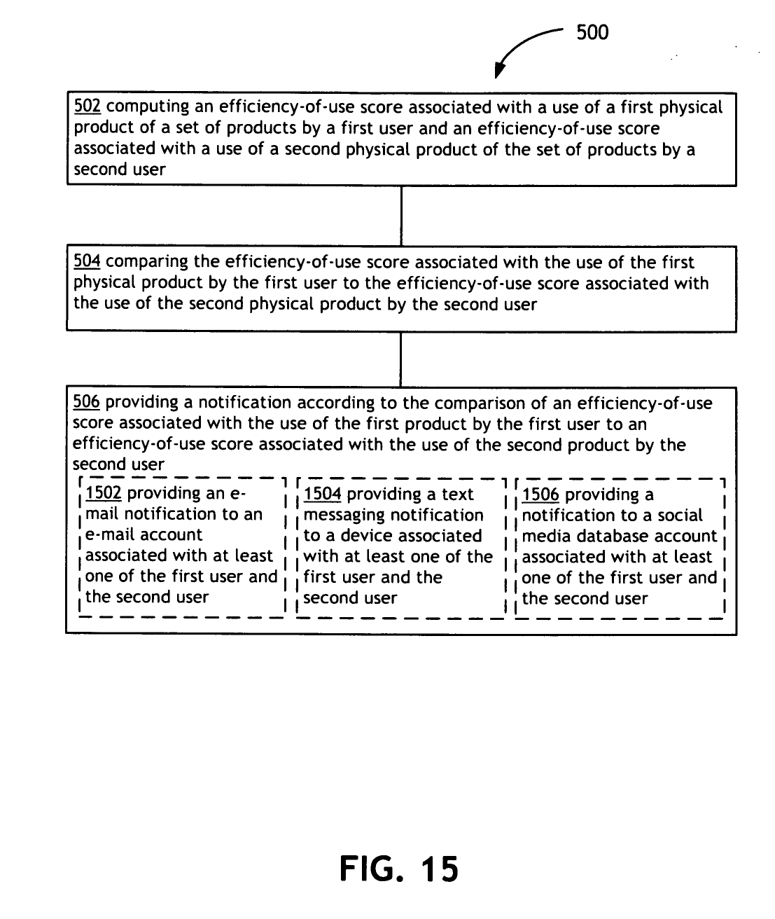

Referring to FIG. 15, FIG. 15 illustrates an example embodiment where operation 506 of the example operational flow 500 of FIG. 5 may include at least one additional operation. Additional operations may include an operation 1502, 1504 and/or 1506.

Operation 1502 shows providing an e-mail notification to an e-mail account associated with at least one of the first user and the second user. For example, upon computing the comparison of the efficiency-of-use score of first user 300A to a efficiency-of-use score of at least one second user (e.g. user 300B and/or user 300C) by the efficiency-of-use module 202 of the product 101 and/or the efficiency-of-use module 405 of the device 309, the network module 307 of the product 101 and/or the network adapter 410 of the device 309 may transmit an e-mail message via network 100 to an e-mail server (not shown) maintaining an e-mail account associated (e.g. registered to) at least one user 300 according to any number of e-mail protocols (e.g. IMAP, POP3, SMTP and HTTP protocols). For example, an e-mail message may be sent to user 300A informing them of the relative efficiency of their most recent use of the product 101 as compared to the uses of the product 101 by user 300B and user 300C. Further, an e-mail message may be sent to user 300B and/or user 300C informing them that user 300A has recently used the product and providing information regarding the relative efficiency of user 300A's recent use of the product 101 as compared to the prior uses of the product 101 by user 300B and user 300C.

Operation 1504 shows providing a text messaging notification to a device associated with at least one of the first user and the second user. For example, upon computing the comparison of the efficiency-of-use score of first user 300A to a efficiency-of-use score of at least one second user (e.g. user 300B and/or user 300C) by the efficiency-of-use module 202 of the product 101 and/or the efficiency-of-use module 405 of the device 309, the network module 307 of the product 101 and/or the network adapter 410 of the device 309 may transmit a text message via network 100 to a device 309 associated with (e.g. owned by) at least one user 300 according to any number of text messaging protocols (e.g. SMS text message protocols). For example, a text message may be sent to device 309A associated with user 300A informing them of the relative efficiency of their most recent use of the product 101 as compared to the uses of the product 101 by user 300B and user 300C. Further, a text message may be sent to device 309B associated with user 300B and/or device 309C associated with user 300C informing them that user 300A has recently used the product and providing information regarding the relative efficiency of user 300A's recent use of the product 101 as compared to the prior uses of the product 101 by user 300B and user 300C.

Operation 1506 shows providing a notification to a social media database account associated with at least one of the first user and the second user. For example, upon computing the comparison of the efficiency-of-use score of first user 300A to a efficiency-of-use score of at least one second user (e.g. user 300B and/or user 300C) by the efficiency-of-use module 202 of the product 101 and/or the efficiency-of-use module 405 of the device 309, the network module 307 of the product 101 and/or the network adapter 410 of the device 309 may post a notification of the comparison to a social media database account (e.g. a Facebook®, Twitter®, Google+®, etc.) associated with (e.g. registered to) at least one user 300 via network 100 to a device 309. For example, a notification of the comparison may be automatically posted to the social media database account of user 300A describing the relative efficiency of their most recent use of the product 101 as compared to the uses of the product 101 by user 300B and user 300C so that individuals having access to the media database account of user 300A may view the notification. Further, a notification of the comparison may be automatically posted to the social media database account of user 300B and user 300C describing the relative efficiency of user 300A's recent use of the product 101 as compared to the prior uses of the product 101 by user 300B and user 300C so that individuals having access to the media database account of user 300B and user 300B may view the notification.

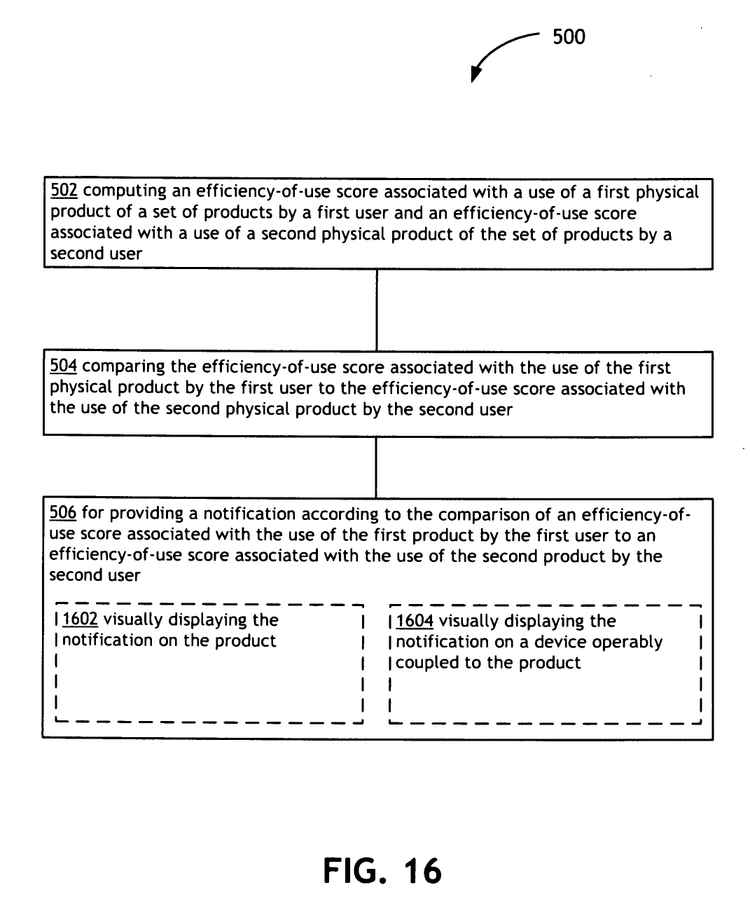

Referring to FIG. 16, FIG. 16 illustrates an example embodiment where operation 506 of the example operational flow 500 of FIG. 5 may include at least one additional operation. Additional operations may include an operation 1602 and/or 1604.

Further, it may be desirable to provide near-real-time notifications regarding the comparative efficiency of the use of the product 101 by a user 300 to the user 300 so that they may vary their usage accordingly. As such, the notifications regarding comparative efficiency of the use of the product 101 may be provided to users 300 in a manner such that the notification is received in proximity to the product 101.

Operation 1602 shows visually displaying the notification on the product. Referring to FIG. 3, as noted above, user interface 301 of product 101 may include a display device (e.g. an LCD display, LED indicators, touch-screen, etc). Following the comparison of a use of product 101 by user 300A to a use of the product by at least user 300B by the efficiency-of-use module 202 of the product 101 and/or system 108 or the efficiency-of-use module 405 of the device 309, one or more signals indicative of that efficiency-of-use score may be provided to the user interface 301 of the product 101 for presentation to a user 300 via a display element of the user interface 301. For example, an LCD display element of the user interface 301 may provide a graphical depiction of the relative efficiency-of-use scores for uses of product 101 by user 300A and user 300A (e.g. a bar graph showing the efficiency-of-use score of user 300A relative to the efficiency-of-use score of at least user 300B).

Operation 1604 shows visually displaying the notification on a device operably coupled to the product. Referring to FIG. 4, as noted above, user interface 401 of device 309 may include a display device (e.g. an LCD display, LED indicators, touch-screen, etc). Following the comparison of at least one efficiency-of-use score for a use of product 101 by user 300A to a use of the product by at least user 300B by the efficiency-of-use module 202 of the product 101 and/or system 108 or the efficiency-of-use module 405 of the device 309, one or more signals indicative of that efficiency-of-use score may be provided to the user interface 401 of device 309 for presentation to a user 300 via a display element of user interface 401. For example, an LCD display element of the user interface 401 may provide a graphical depiction of the efficiency-of-use score for a use of product 101 by a user 300 relative efficiency-of-use scores for uses of product 101 by user 300A and user 300A (e.g. a bar graph showing the efficiency-of-use score of user 300A relative to the efficiency-of-use score of at least user 300B).

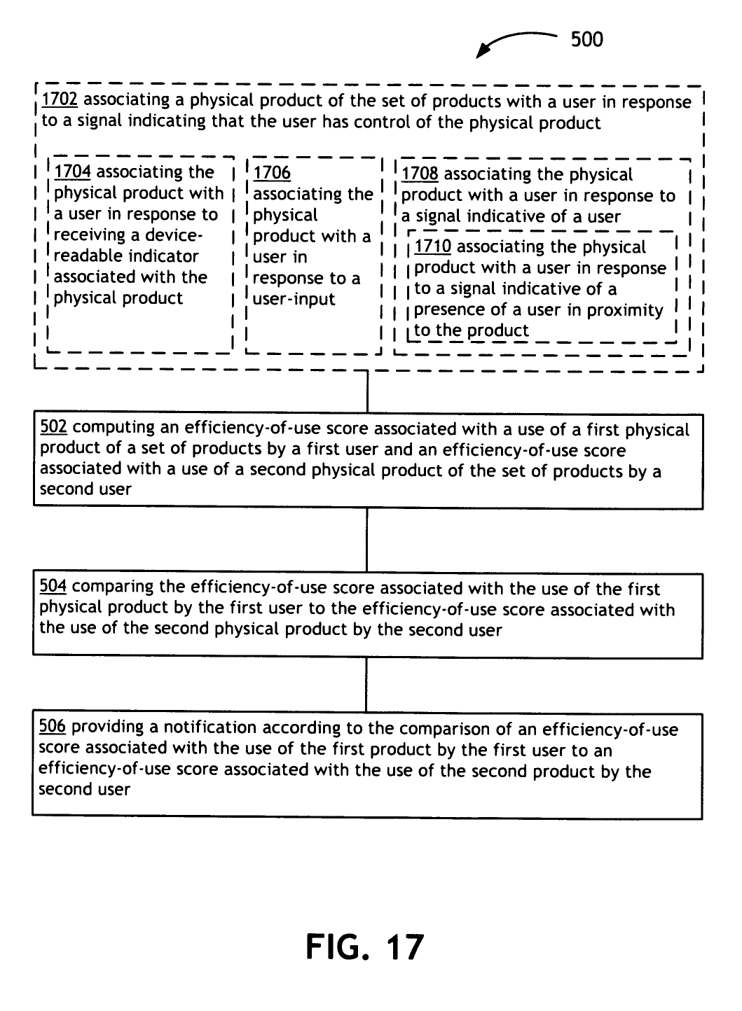

Referring to FIG. 17, FIG. 17 illustrates an example embodiment where the example operational flow 500 of FIG. 5 may include at least one additional operation. Additional operations may include an operation 1702, 1704, 1706, 1708 and/or 1710.

Operation 1702 illustrates associating a physical product of the set of products with a user in response to a signal indicating that the user has control of the physical product. For example, referring to FIGS. 1-4, association module 201 can be configured to link a user account 204 for a first user 300A, with product 101A and store the information in user account database 203. The association module 201 can be configured to link user account 204 with product 101A in response to receipt of a signal by network module 307 that indicates that first user 300A has control of, i.e., is using, has purchased, etc., product 101A. For example, network module 307 could receive one or more packets of information indicative of an XML package that includes fields that identify product 101A, the user account 204 for user 300A, and an indication that user 300A has taken control of, i.e., possesses, product 101A.

In an exemplary embodiment, each user 300 may have their own user account 204. However, in another embodiment, multiple users may share a user account 204 and/or the user account 204 could be associated with an entity such as a family unit or a corporation. For example, a user account 204 could be for the “Smith family.” In this example, when any member of the Smith family, e.g., Mr. Smith or Ms. Smith, takes control of product 101 a signal can be received by association module 201 and information can be stored that indicates that a member of the Smith family has taken control of product 101.

In a specific example, association module 201 can have access to and/or include a table that can store information that links products to users. For example, association module 201 can include a list of products and a list of user accounts. In response to receipt of a signal indicating a first user 300A has taken control of product 101A, association module 201 can be configured to link product 101A with user account 204 by storing information that uniquely identifies product 101 in, for example, product list 205.

Referring briefly to FIG. 3, suppose that product 101A is an automobile and first user 300A decides to use it to drive to, for example, the store. In this example, user 300 can take control of the automobile, e.g., by renting it from a company, borrowing it from a friend, reserving it from a service provider, checking it out from a community organization, etc., and a signal can be sent to system 108 that indicates that user 300A has taken control of the automobile. In this specific example, system 108 may be controlled by a rental company.

In another specific example, user 300A may purchase product 101 from, for example, product retailer 103. In this example, an agent of the product retailer 103 and/or user 300A could link product 101A to the user account 204 associated with user 300A. For example, the agent could query the device-readable indicator 303 via the product 101A or device 309A to produce a signal that can be sent to system 108 that indicates that user 300A has taken control of product 101A.

Operation 1704 shows associating a physical product with a user in response to receiving a device-readable indicator associated with the physical product. For example, as shown in FIGS. 3-4, a device-readable indicator 303, which could be a unique alphanumeric value, can be used to identify the product within system 108. In this example, a message could be received by network adapter 410 that includes device-readable indicator 303 for product 101 and a user account identifier for the user account 204. The association module 201 can use device-readable indicator 303 to search through product list 205 and link the product 101 to user account 204.

Operation 1706 shows associating a physical product with a user in response to a user-input. For example, as shown in FIGS. 3-4, a user 300 may provide a user input (e.g. a touch-based input to a touch sensitive component of user interface 301 of the product 101 or user interface 401 of the device 309 such as a keypad, touch screen, fingerprint reader) such as a PIN code, password, fingerprint scan or any other data uniquely identifying a user 300 (e.g. user 300A) within the set of users 300. The association module 201 may receive the user input and create an entry in the user account 204 of the user account database 203 associated with the user 300A indicative of a current association of the product 101 with user 300A.

Operation 1708 shows associating a physical product with a user in response to a signal indicative of a user. For example, as shown in FIG. 3 a user 300 may be associated with (e.g. have physical control of as determined by sensor module 402, have an billing account associated with, etc.) a device 309. The network adapter 410 of the device 309 may communicate with the network module 307 of the product 101 to provide a signal indicative of a user 300 (e.g. user 300A) such as a user ID, PIN code, password, etc., to the product 101. The association module 201 may receive the signal indicative of the user 300A and create an entry in the user account 204 of the user account database 203 associated with the user 300A indicative of a current association of the product 101 with user 300A.

Operation 1710 shows associating a physical product with a user in response to a signal indicative of a presence of a user in proximity to the product. For example, as shown in FIG. 3 a user 300 may be associated with (e.g. have physical control of as determined by sensor module 402, have an billing account associated with, etc.) a device 309. The device 309 may include device location determination module 412 (e.g. a GPS module) configured to determine a location of the device 309. Similarly, the product 101 may include product location determination module 308 (e.g. a GPS module) configured to determine a location of the product 101. The network adapter 410 of the device 309 may communicate with the network module 307 of the product 101 to provide a signal indicative of a location of the user 300 and/or the product location determination module 308 of the product 101. The association module 201 and/or the association module 403 may receive the signal indicative of the location of the user 300 and/or product 101 and compute a relative distance between the location of the user 300 and the product 101 and compare the distance to a proximity threshold. If the distance between the location of the user 300 and the product 101 is less than the proximity threshold, it may be viewed as indicating that the product 101 is associated with the user 300. Upon such a determination, the association module 201 and/or the association module 403 may create an entry in the user account 204 of the user account database 203 associated with the user 300A indicative of a current association of the product 101 with user 300A. Alternately, other mechanisms for determining the proximity of the user 300 to the product 101 may be employed such as image recognition, voice recognition, network connectivity (e.g. a Bluetooth connection between the product 101 and device 309), and the like.

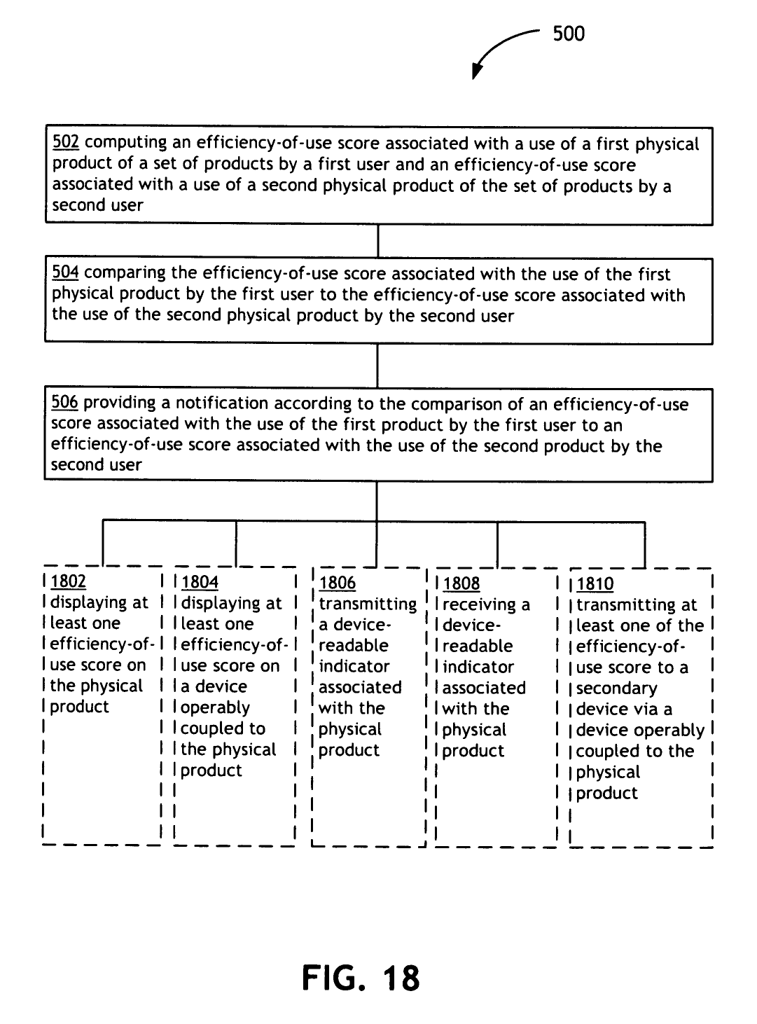

Referring to FIG. 18, FIG. 18 illustrates an example embodiment where the example operational flow 500 of FIG. 5 may include at least one additional operation. Additional operations may include an operation 1802, 1804, 1806, 1808 and/or 1810.

Operation 1802 shows displaying at least one efficiency-of-use score on a physical product of the set of physical products. Referring to FIG. 3, as noted above, user interface 301 of product 101 may include a display device (e.g. an LCD display, LED indicators, touch-screen, etc). Following the computation of at least one efficiency-of-use score for a use of product 101 by a user 300 by the efficiency-of-use module 202 of the product 101 and/or system 108 or the efficiency-of-use module 405 of the device 309, one or more signals indicative of that efficiency-of-use score may be provided to the user interface 301 of the product 101 for presentation to a user 300 via a display element of the user interface 301. For example, an LCD display element of the user interface 301 may provide a graphical depiction of the efficiency-of-use score for a use of product 101 by a user 300 (e.g. a bar graph showing the efficiency-of-use score relative to an optimal efficiency-of-use score). Alternately, an LED indicator display element of the user interface 301 may provide an indicator depicting the efficiency-of-use score for a use of product 101 by a user 300 (e.g. moving sequence of LEDs showing the efficiency-of-use score relative to an optimal efficiency-of-use score).

Operation 1804 shows displaying at least one efficiency-of-use score on a device operably coupled to a physical product of the set of physical products. Referring to FIG. 4, as noted above, user interface 401 of device 309 may include a display device (e.g. an LCD display, LED indicators, touch-screen, etc). Following the computation of at least one efficiency-of-use score for a use of product 101 by a user 300 by the efficiency-of-use module 202 of the product 101 and/or system 108 or the efficiency-of-use module 405 of the device 309, one or more signals indicative of that efficiency-of-use score may be provided to the user interface 401 of device 309 for presentation to a user 300 via a display element of user interface 401. For example, an LCD display element of the user interface 401 may provide a graphical depiction of the efficiency-of-use score for a use of product 101 by a user 300 (e.g. a bar graph showing the efficiency-of-use score relative to an optimal efficiency-of-use score). Alternately, an LED indicator display element of the user interface 401 may provide an indicator depicting the efficiency-of-use score for a use of product 101 by a user 300 (e.g. moving sequence of LEDs showing the efficiency-of-use score relative to an optimal efficiency-of-use score).

Operation 1806 shows transmitting a device-readable indicator associated with a physical product of the set of physical products. For example, and referring to FIG. 3, a device-readable indicator 303 associated with the product 101 (e.g. a unique alphanumeric value) can be used to identify the product within system 108. In this example, a message could be transmitted by network module 307 of product 101 that includes device-readable indicator 303 for product 101 and a user account identifier for the user account 204 of a user 300.

Operation 1808 shows receiving a device-readable indicator associated with a physical product of the set of physical products. For example, and referring to FIGS. 3-4, a device-readable indicator 303 associated with the product 101 (e.g. a unique alphanumeric value) can be used to identify the product within system 108. In this example, a message could be transmitted by network module 307 of product 101 that includes device-readable indicator 303 for product 101 and a user account identifier for the user account 204 of a user 300. The message may be received by network adapter 410 of a device 309. Upon receipt of the message including the device-readable indicator 303, association module 403 can use device-readable indicator 303 to search through product list 205 to link the product 101 to user account 204.

Operation 1810 shows transmitting at least one of an efficiency-of-use score to a secondary device via a device operably coupled to a physical product of the set of physical products. Referring to FIG. 4, as noted above, an efficiency-of-use score may be computed by the product 101 and/or a device 309 operably coupled to the product 101. Following the computation of at least one efficiency-of-use score for a use of product 101 by a user 300 by the efficiency-of-use module 202 of the product 101 and/or system 108 or the efficiency-of-use module 405 of the device 309, one or more signals indicative of that efficiency-of-use score may be transmitted by the device 309 operably coupled to the product 101. For example, a message including the efficiency-of-use score may be transmitted by the network adapter 410 of the device 309C operably coupled to the product 101 to the network module 109 of the system 108 via the network 100 and/or back to the network module 307 of the product 101.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

What is claimed:

1. A system comprising:
means for computing an efficiency-of-use score associated with a use of a first physical product of a set of products by a first user and an efficiency-of-use score associated with a use of a second physical product of the set of products by a second user;
means for comparing the efficiency-of-use score associated with the use of the first physical product by the first user to the efficiency-of-use score associated with the use of the second physical product by the second user; and
means for providing a notification according to the comparison of an efficiency-of-use score associated with the use of the first product by the first user to an efficiency-of-use score associated with the use of the second product by the second user.

2. The system of claim 1, wherein at least one of the means for computing an efficiency-of-use score associated with a use of a first physical product of a set of products by a first user and an efficiency-of-use score associated with a use of a second physical product of the set of products by a second user comprises:
means for computing an efficiency-of-use score from at least information that defines an efficiency-of-use pattern for a physical product.

3. The system of claim 1, wherein at least one of the means for computing an efficiency-of-use score associated with a use of a first physical product of a set of products by a first user and an efficiency-of-use score associated with a use of a second physical product of the set of products by a second user comprises:
means for computing an efficiency-of-use score using information set by a service provider.

4. The system of claim 1, wherein at least one of the means for computing an efficiency-of-use score associated with a use of a first physical product of a set of products by a first user and an efficiency-of-use score associated with a use of a second physical product of the set of products by a second user comprises:
means for computing an efficiency-of-use score using information set by a group of users.

5. The system of claim 1, wherein at least one of the means for computing an efficiency-of-use score associated with a use of a first physical product of a set of products by a first user and an efficiency-of-use score associated with a use of a second physical product of the set of products by a second user further comprises:
means for computing an efficiency-of-use score from at least information associated with at least one use characteristic of a physical product of the set of physical products.

6. The system of claim 5, wherein the means for computing an efficiency-of-use score from at least information associated with at least one use characteristic of a physical product of the set of physical products comprises:
means for computing an efficiency-of-use score from at least temperature data generated by a temperature monitoring sensor over the period of time that a user has control of a physical product of the set of physical products.

7. The system of claim 5, wherein the means for computing an efficiency-of-use score from at least information associated with at least one use characteristic of a physical product of the set of physical products comprises:
means for computing an efficiency-of-use score from at least pressure data generated by a pressure monitoring sensor over the period of time that a user has control of a physical product of the set of physical products.

8. The system of claim 5, wherein the means for computing an efficiency-of-use score from at least information associated with at least one use characteristic of a physical product of the set of physical products comprises:
means for computing an efficiency-of-use score from at least information obtained from at least one image over the period of time that a user has control of a physical product of the set of the physical products.

9. The system of claim 5, wherein the means for computing an efficiency-of-use score from at least information associated with at least one use characteristic of a physical product of the set of physical products comprises:
means for computing an efficiency-of-use score from at least information obtained by a laser over the period of time that a user has control of a physical product of the set of the physical products.

10. The system of claim 5, wherein the means for computing an efficiency-of-use score from at least information associated with at least one use characteristic of a physical product of the set of physical products comprises:
means for computing an efficiency-of-use score from at least vibration information generated from a vibration monitoring sensor over the period of time that a user has control of a physical product of the set of the physical products.

11. The system of claim 5, wherein the means for computing an efficiency-of-use score from at least information associated with at least one use characteristic of a physical product of the set of physical products comprises:
means for computing an efficiency-of-use score from at least impact data generated by an impact sensor over the period of time that a user has control of a physical product of the set of the physical products.

12. The system of claim 5, wherein the means for computing an efficiency-of-use score from at least information associated with at least one use characteristic of a physical product of the set of physical products comprises:
means for computing an efficiency-of-use score from at least corrosion data generated by a corrosion sensor over the period of time that a user has control of a physical product of the set of the physical products.

13. The system of claim 5, wherein the means for computing an efficiency-of-use score from at least information associated with at least one use characteristic of a physical product of the set of physical products comprises:
means for computing an efficiency-of-use score from at least an output of a sensor configured to measure concentrations of metallic elements in a lubricant over the period of time that a user has control of a physical product of the set of the physical products.

14. The system of claim 5, wherein the means for computing an efficiency-of-use score from at least information associated with at least one use characteristic of a physical product of the set of physical products comprises:
means for computing an efficiency-of-use score from information obtained by a diagnostic computing device associated with the physical product over the period of time that a user has control of a physical product of the set of the physical products.

15. The system of claim 5, wherein the means for computing an efficiency-of-use score from at least information associated with at least one use characteristic of a physical product of the set of physical products comprises:
means for computing an efficiency-of-use score from at least revolutions per minute data generated by a tachometer over the period of time that a user has control of a physical product of the set of the physical products.

16. The system of claim 5, wherein the means for computing an efficiency-of-use score from at least information associated with at least one use characteristic of a physical product of the set of physical products comprises:
means for computing an efficiency-of-use score from at least status information associated with a battery over the period of time that a user has control of a physical product of the set of the physical products.

17. The system of claim 5, wherein the means for computing an efficiency-of-use score from at least information associated with at least one use characteristic of a physical product of the set of physical products comprises:
means for computing an efficiency-of-use score from at least information associated with processor utilization over the period of time that a user has control of a physical product of the set of the physical products.

18. The system of claim 5, wherein the means for computing an efficiency-of-use score from at least information associated with at least one use characteristic of a physical product of the set of physical products comprises:
means for computing an efficiency-of-use score from at least information associated with an amount of energy consumed over the period of time that a user has control of a physical product of the set of the physical products.

19. The system of claim 5, wherein the means for computing an efficiency-of-use score from at least information associated with at least one use characteristic of a physical product of the set of physical products comprises:
means for computing an efficiency-of-use score from at least information associated with an estimated amount of work per unit of fuel achieved by the physical product over the period of time that a user has control of a physical product of the set of the physical products.

20. The system of claim 5, wherein the means for computing an efficiency-of-use score from at least information associated with at least one use characteristic of a physical product of the set of physical products comprises:
means for computing an efficiency-of-use score from at least information associated with an estimated amount of miles per gallon of gasoline achieved by the physical product over the period of time that a user has control of a physical product of the set of the physical products.

21. The system of claim 5, wherein the means for computing an efficiency-of-use score from at least information associated with at least one use characteristic of a physical product of the set of physical products comprises:
means for computing an efficiency-of-use score from at least information associated with mileage driven over the period of time that a user has control of a physical product of the set of the physical products.

22. The system of claim 5, wherein the means for computing an efficiency-of-use score from at least information associated with at least one use characteristic of a physical product of the set of physical products comprises:
means for computing an efficiency-of-use score from at least sound information for the physical product generated by a microphone over the period of time that a user has control of a physical product of the set of the physical products.

23. The system of claim 5, wherein the means for computing an efficiency-of-use score from at least information associated with at least one use characteristic of a physical product of the set of physical products comprises:
means for computing an efficiency-of-use score from at least information associated with an amount of light reflected by the physical product over the period of time that a user has control of a physical product of the set of the physical products.

24. The system of claim 5, wherein the means for computing an efficiency-of-use score from at least information associated with at least one use characteristic of a physical product of the set of physical products comprises:
means for computing an efficiency-of-use score from at least information associated with an amount of bandwidth used by the physical product over the period of time that a user has control of a physical product of the set of physical products.

25. The system of claim 5, wherein the means for computing an efficiency-of-use score from at least information associated with at least one use characteristic of a physical product of the set of physical products comprises:
means for computing an efficiency-of-use score from at least information associated with an amount of physical damage to the physical product that occurred over the period of time that a user has control of a physical product of the set of physical products.

26. The system of claim 5, wherein the means for computing an efficiency-of-use score from at least information associated with at least one use characteristic of a physical product of the set of physical products comprises:
means for computing an efficiency-of-use score from at least information associated with a product control element.

27. The system of claim 1, wherein at least one of means for computing an efficiency-of-use score associated with a use of a first physical product of a set of products by a first user and an efficiency-of-use score associated with a use of a second physical product of the set of products by a second user comprises:
means for computing at least one efficiency-of-use score with the physical product.

28. The system of claim 1, wherein at least one of means for computing an efficiency-of-use score associated with a use of a first physical product of a set of products by a first user and an efficiency-of-use score associated with a use of a second physical product of the set of products by a second user comprises:
means for computing an efficiency-of-use score with a device operably coupled to the physical product.

29. The system of claim 28, wherein the means for computing an efficiency-of-use score with a device operably coupled to the physical product comprises:
means for computing at least one efficiency-of-use score with a device wirelessly coupled to a physical product of the set of physical products.

30. The system of claim 1, wherein the means for providing a notification according to the comparison of an efficiency-of-use score associated with the use of the first product by the first user to an efficiency-of-use score associated with the use of the second product by the second user comprises:
means for providing an e-mail notification to an e-mail account associated with at least one of the first user and the second user.

31. The system of claim 1, wherein the means for providing a notification according to the comparison of an efficiency-of-use score associated with the use of the first product by the first user to an efficiency-of-use score associated with the use of the second product by the second user comprises:
means for providing a text messaging notification to a device associated with at least one of the first user and the second user.

32. The system of claim 1, wherein the means for providing a notification according to the comparison of an efficiency-of-use score associated with the use of the first product by the first user to an efficiency-of-use score associated with the use of the second product by the second user comprises:
means for providing a notification to a social media database account associated with at least one of the first user and the second user.

33. The system of claim 1, wherein the means for providing a notification according to the comparison of an efficiency-of-use score associated with the use of the first product by the first user to an efficiency-of-use score associated with the use of the second product by the second user comprises:
means for visually displaying the notification on the product.

34. The system of claim 1, wherein the means for providing a notification according to the comparison of an efficiency-of-use score associated with the use of the first product by the first user to an efficiency-of-use score associated with the use of the second product by the second user comprises:
means for visually displaying the notification on a device operably coupled to the product.

35. The system of claim 1, further comprising:
means for associating a physical product of the set of products with a user in response to a signal indicating that the user has control of the physical product.

36. The method of claim 35, wherein the means for associating a physical product of the set of products with a user in response to a signal indicating that the user has control of the physical product comprises:
means for associating a physical product with a user in response to receiving a device-readable indicator associated with the physical product.

37. The method of claim 35, wherein the means for associating a physical product of the set of products with a user in response to a signal indicating that the user has control of the physical product comprises:
means for associating a physical product with a user in response to a user-input.

38. The method of claim 35, wherein the means for associating a physical product of the set of products with a user in response to a signal indicating that the user has control of the physical product comprises:
means for associating a physical product with a user in response to a signal indicative of a user.

39. The method of claim 35, wherein at least one of the means for associating a physical product with a user in response to a signal indicative of a user comprises:
means for associating a physical product with a user in response to a signal indicative of a presence of a user in proximity to the product.

40. The system of claim 1, further comprising:
means for displaying at least one efficiency-of-use score on a physical product of the set of physical products.

41. The system of claim 1, further comprising:
means for displaying at least one efficiency-of-use score on a device operably coupled to a physical product of the set of physical products.

42. The system of claim 1, further comprising:
means for transmitting a device-readable indicator associated with a physical product of the set of physical products.

43. The system of claim 1, further comprising:
means for receiving a device-readable indicator associated with a physical product of the set of physical products.

44. The system of claim 1, further comprising:
means for transmitting at least one of an efficiency-of-use score to a secondary device via a device operably coupled to a physical product of the set of physical products.

45. A method comprising:
computing an efficiency-of-use score associated with a use of a first physical product of a set of products by a first user and an efficiency-of-use score associated with a use of a second physical product of the set of products by a second user;
comparing the efficiency-of-use score associated with the use of the first physical product by the first user to the efficiency-of-use score associated with the use of the second physical product by the second user; and
providing a notification according to the comparison of an efficiency-of-use score associated with the use of the first product by the first user to an efficiency-of-use score associated with the use of the second product by the second user.

46. A system comprising:
circuitry for computing an efficiency-of-use score associated with a use of a first physical product of a set of products by a first user and an efficiency-of-use score associated with a use of a second physical product of the set of products by a second user;
circuitry for comparing the efficiency-of-use score associated with the use of the first physical product by the first user to the efficiency-of-use score associated with the use of the second physical product by the second user; and
circuitry for providing a notification according to the comparison of an efficiency-of-use score associated with the use of the first product by the first user to an efficiency-of-use score associated with the use of the second product by the second user.
